(19) United States
(12) Patent Application Publication
(10) Pub. No.: US 2025/0045715 A1
(43) Pub. Date: Feb. 6, 2025

(54) MULTI-TENANT LICENSING AND SUBSCRIPTION MANAGEMENT

(71) Applicant: Hint, Inc., Pleasanton, CA (US)

(72) Inventors: Muthanna Nischal Ammatanda, Fremont, CA (US); Gaurav Jhaveri, San Mateo, CA (US); Michael Olsen Craig, JR., Tucson, AZ (US); Maria del Carmen Solanas Vanrell, Santa Clara, CA (US)

(21) Appl. No.: 18/362,524

(22) Filed: Jul. 31, 2023

(51) Int. Cl. G06Q 20/10; G06Q 50/10

(52) U.S. Cl. CPC G06Q 20/102; G06Q 50/10

(57) ABSTRACT

Examples relate generally to a multi-tenant licensing and subscription management. More specifically, but not by way of limitation, embodiments relate to systems, methods, and media for enabling an interactive management platform and providing convenient user interfaces for subscription and license management. Examples provide highly-configurable features for incorporating enhanced technology in the form of convenient platform tools and applications for licensing and subscription management in a multi-tenant network.

### TECHNICAL FIELD

Examples herein relate generally to a multi-tenant licensing and subscription management. More specifically, but not by way of limitation, embodiments relate to systems, methods, and media for enabling an interactive management platform and providing convenient user interfaces for subscription and license management. Examples provide highly-configurable features for incorporating enhanced technology in the form of convenient platform tools and applications for licensing and subscription management in a multi-tenant network.

### BACKGROUND

User interfaces and data structures pertaining to the management of subscriptions and license fees (e.g., for goods or services), while having advanced in recent years, have not been optimized for use in a cross number of verticals and also for the management of more complicated subscription arrangements between providers and customers in a multi-tenant network.

One prior art system for providing subscriptions to a bundle of services, and more specifically channels from a program guide, is described in U.S. Pat. No. 7,596,797 (the '797 patent). Here, a terminal controller is used to select a bundle of channels based on a subscription matrix of a user. However, the technology described in the '797 patent is inflexible, lacks configurability by a service provider and also provides a limited set of options for an end-user or consumer.

### BRIEF DESCRIPTION OF THE SEVERAL VIEWS OF THE DRAWINGS

FIG. 1 illustrates a networked multi-tenant network in which the described technology, according to some example embodiments, may be deployed.

FIG. 2 is a diagrammatic representation of a processing environment, in accordance with one embodiment.

FIG. 3 illustrates further details regarding the subcomponents of a licensing and subscription management system, according to some example embodiments.

FIG. 4 is a block diagram illustrating further architectural details of a licensing and subscription management system, according to some example embodiments.

FIG. 5 is a diagrammatic representation of data structures maintained by a licensing and subscription management system, according to some example embodiments.

FIG. 6 is a block diagram of a data architecture, according to some example embodiments.

FIG. 7 is a table diagram illustrating further details of data, according to some example embodiments, stored within the various tables discussed above with reference to FIG. 6.

FIG. 8 is a table diagram illustrating further details of data, according to some example embodiments, stored within the various tables discussed above with reference to FIG. 6.

FIG. 9 is a table diagram illustrating further details of data, according to some example embodiments, stored within the various tables discussed above with reference to FIG. 6.

FIG. 10 is a table diagram illustrating further details of data, according to some example embodiments, stored within the various tables discussed above with reference to FIG. 6.

FIG. 11 illustrates example operations of a method in accordance with an example embodiment.

FIG. 12 illustrates example operations of a method in accordance with an example embodiment.

FIG. 13 to FIG. 41 illustrate examples user interfaces of a tenant patient view in accordance with example embodiment.

FIG. 42 illustrates a method 4200 in accordance with one embodiment.

FIG. 43 illustrates an aspect of the subject matter in accordance with one embodiment.

FIG. 44 is a block diagram showing an example point-of-sale system for conducting transactions over a network, according to some embodiments.

FIG. 45 is a block diagram illustrating a networked environment in which the described technology, according to some example embodiments, may be deployed.

FIG. 46 illustrates the training and use of a machine-learning program, according to some embodiments.

FIG. 47 illustrates a networked environment in which the described technology, according to some example embodiments, may be deployed.

FIG. 48 is a schematic diagram illustrating aspects of encryption, according to some examples.

FIG. 49 illustrates a block diagram of a software architecture, according to some example embodiments.

FIG. 50 illustrates a diagrammatic representation of a machine in the form of a computer system within which a set of instructions may be executed for causing the machine to perform any one or more of the methodologies discussed herein, according to an example embodiment.

### DETAILED DESCRIPTION

In some examples, a multi-tenant licensing and subscription management system includes a processor and a memory storing instructions that, when executed by the processor, configure the licensing and subscription management system to perform operations including providing, for a tenant practice in a multi-tenant network, an interaction platform for receiving, via a platform user interface, health-related subscriptions from a tenant patient, the platform including a suite of invokable tenant-selectable features for processing data relating to the subscriptions and/or operations of the tenant practice, including, in the platform user interface, a first toggle feature selectable by the tenant practice to toggle between a tenant practice view flow and a tenant patient view flow, via an interface in the tenant practice view flow, receiving from a tenant practice, a selection of one or more of the tenant-selectable features, calculating a tenant-configurable practice license fee based on the selection of one or more of the tenant-selectable features, accessing first order data relating to a first subscription offering to the tenant patient, the first order data including a first set of attributes relating to the first subscription offering, accessing second order data related to a second subscription offering to the tenant patient, the second order data including a second set of attributes related to the second subscription offering, combining the license fee and the first and second order data into a licensing and subscription data structure that includes quantity data and period data for each of the first and second subscription offerings, calculating a combined one-time payment amount for both the first and second subscription offerings based on the quantity data, calculating a combined periodic monthly subscription payment amount for both the first and the second subscription offerings based on the quantity and period data, causing presentation, in a user interface in the tenant patient view flow, of both the combined one-time payment amount and the combined monthly subscription payment amount, and causing presentation, in a user interface in the tenant practice view flow, of the tenant-configurable practice license fee.

The licensing and subscription management system may also include where the presentation in the tenant patient view includes presentation of a first user interface element to present the combined one-time payment amount and a second user element to present the combined monthly subscription payment amount, and presentation of a second toggle feature to toggle between the presentations of the first and second user interface elements.

The licensing and subscription management system may also include where the operations further comprise receiving third order data relating to a third offering, the third offering having a one-time payment option only, where the presentation includes a presentation of a one-time payment amount related to the third offering in conjunction with each of the combined one-time payment amount and the combined monthly subscription payment amount.

The licensing and subscription management system may also include where each of the first and second set of attributes includes an item identifier associated with at least one of an item or a service included in the offering.

The licensing and subscription management system may also include where each of the first and second set of attributes includes a recurring attribute identifying the respective offering as being recur offering, and where the combining of the first and second order data is performed based on each of the first and second subscription offerings being identified as recurring offerings.

The licensing and subscription management system may also include where the operations further comprise communicating the combined monthly subscription payment amount from the licensing and licensing and subscription management system to a financial exchange system, the financial exchange system operating to present financing options relating to the combined monthly subscription payment amount to financiers.

The licensing and subscription management system may also include where the suite of invokable tenant-selectable features includes one or more of a catalog concierge, a membership status, an instant promotion, a tenant practice insight, a tenant patient insight, a tenant patient import, a tenant patient checkout, a next day funding, a card present payment status or checkout flow, a card not present payment status or check out flow, a risk monitoring option or status, a dispute management tool, a tenant practice onboarding tool, a tenant patient onboarding tool, a multi-location payment tool, a multi-device payment tool, a license fee and subscription management tool, a payment operations analysis, a device management tool, and a PCI compliance monitoring tool.

The licensing and subscription management system may also include where the communication of the combined monthly subscription payment amount includes communicating further information pertaining to each of the first and second subscription offerings, the further information including identification information for a provider of the subscription offering, and identification information for a consumer of the subscription offering.

The licensing and subscription management system may also include where the operations further comprise receiving, at the financial exchange system, a financing offer related to at least one of the first or the second subscription offerings, the financing offer including financing terms, and further include communicating the financing offer from the financial exchange system to the licensing and licensing and subscription management system for presentation to a consumer.

The licensing and subscription management system may also include where the financing offer includes both a first financing offer pertaining to the first subscription offering and a second financing offer pertaining to the second subscription offering.

The licensing and subscription management system may also include where the licensing and licensing and subscription management system automatically applies predefined business rules to the first and second financing offers in order to selectively present at least one of the first or second financing offers to the consumer. Other technical features may be readily apparent to one skilled in the art from the following figures, descriptions, and claims.

Such examples can provide solutions for technical problems because creating and managing licensing and subscription programs across many different tenants, each with their own systems and requirements, requires solving many technical challenges around integration, data management, and configuration. Examples described herein solve these challenges by providing a licensing and subscription management system that can be configured for each tenant's needs.

Allowing each tenant to have a unique licensing and subscription program requires a technical solution that can be flexibly configured and customized for each tenant. The inventive subject matter solves this by allowing each tenant or patient to provide ‘order data’ to configure their specific licensing and/or subscription program.

Providing an interface that is fast and easy to use requires solving technical challenges around user experience design and system performance. The inventive subject matter solves this by using ‘a touchscreen tablet device’ and allowing ‘the customer’ (e.g., a tenant practice or a tenant patient) to configure the licensing and subscription program while watching.

Executing licensing and subscription programs in real-time during payment transactions requires technical solutions by integrating an interactive platform with payment processing systems and calculating aspects such a subscription fees, licensing fees, and loyalty rewards, on-the-fly. The inventive subject matter solves this by operating ‘in conjunction with or as part of a payment facilitator’. So in summary, the inventive examples described herein can solve these technical problems by providing a multi-tenant licensing and subscription management system including an interactive platform that can be configured for each tenant's needs, allows flexible customization of each tenant's program, uses an easy-to-use touchscreen interface, and integrates with payment processing to execute licensing and subscription programs in real-time. The examples thereby enable the creation and management of unique licensing and subscription programs for many different tenants with technical ease.

According to some further example embodiments, there is provided a licensing and subscription management system that generates and uses data structures and interfaces that allow for configurability and flexibility in the creation of a bundle of subscriptions, for a specific consumer, to one or more products or services, which may be delivered in terms of one or more plans. Payment for the bundle of subscriptions, products or services may be made using a “card present” transaction. Sometimes these payments can fail due to system failure, or insufficient source funds for example. A paying user might try the payment again using another source of funds in the hope the payment goes through. Occasionally, a payment might go through twice. As mentioned above, this uncertainty, lack of information, and potential payment duplication is not helpful to the user, or a shop assistant or staff member helping the payer to pay for the bundle, product or service. Some examples herein generate an alert based on a detection that multiple payments are being issued for the same purchase, in order to prevent multiple payments being collected for the same purchase. Examples seek to provide a technical solution assisting users to prevent re-running multiple payments for the same purchase, either inadvertently or due to system glitches.

Each subscription within a bundle of subscriptions can be for a product or service and has a fulfillment price. Further, each subscription has a period in which it may recur (e.g., one month, six months, one year, etc.). These recurrence periods may perpetuate indefinitely or may terminate after a set number of occurrences (or cycles).

Each subscription can furthermore be financed by a loan from a third party, or by a service provider. Alternatively, a consumer can pay the full amount for a subscription at one time (e.g., upon initiation of the subscription). The terms of the subscription (both delivery and financial) can be dynamically managed by consumers in some cases (e.g., a consumer may be able to change the. It over which the subscription may reoccur).

Even further, each subscription may be executed independently of other subscriptions in a bundle, while billing for one or more subscriptions within the bundle may be aggregated into a single payment once a month (or on some other periodic basis). Service plans may, in some embodiments, be made with the assistance of a service delivery expert (e.g., a physician), and may be fulfilled at a place of business of the expert (e.g., a medical practice office of the physician). Product fulfillment, on the other hand, may be performed by shipment.

As noted above, each subscription in a bundle may be financed by a loan from a third party or service provider. In one embodiment, loans may be facilitated in real time. To this end, a licensing and subscription management system communicates details of a particular subscription to a financial exchange in near real-time. The details of a particular description include, for example, identification of the products or services being offered, details of the provider, and details of the consumer. Third-party financiers may access the financial exchange, again in near real-time, to accept any number (or none) of the subscriptions being offered via the financial exchange.

In one embodiment, the receipt of subscription details, the offering of subscription financing opportunities to third-party financiers, and the receipt of acceptance/decline of a financing opportunity may occur in near real-time, and while a customer is standing at the checkout counter of a service consumer.

Defining the quantity and frequency of delivery of a product or service offering under subscription plan is tricky and presents technical challenges to a user. This is particularly so where the product or service offering is being subscribed to is part of a bundle of offerings or services included within a single subscription plan. For example, defining the quantity and frequency of delivery requires typing numerical data into appropriate fields and then calculating variables to display a monthly cost (or payment total) of the subscription plan. Because this area of the software is frequently used on a touchscreen tablet device while the customer is watching, now there is a need to have a fast friction free device to enter the data.

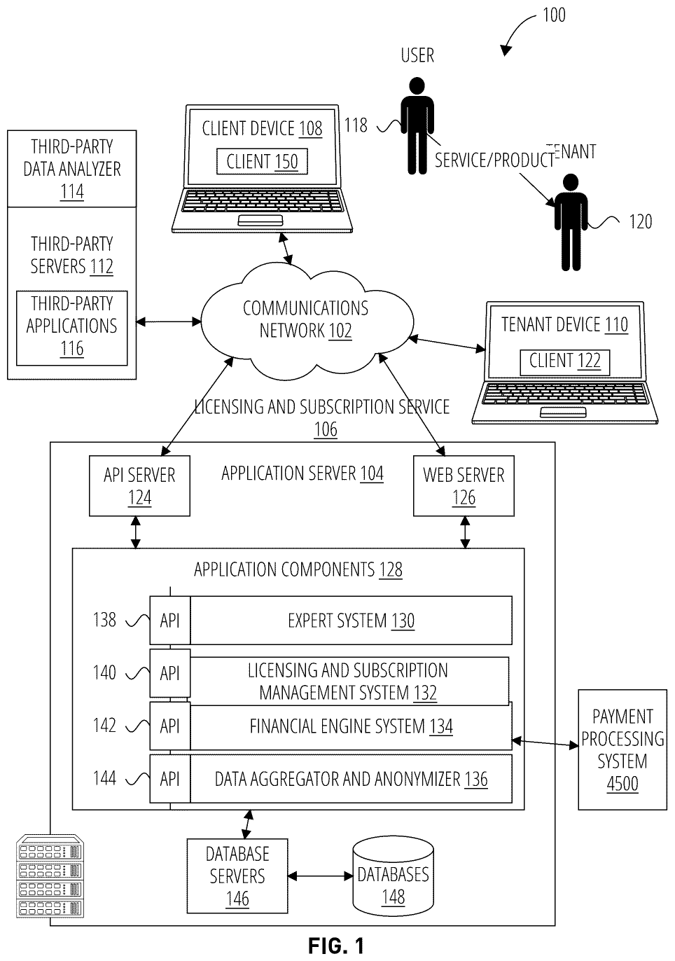

FIG. 1 illustrates a multi-tenant network 100 in which a communications network 102 communicatively couples application servers 104 at a licensing and subscription service 106, a client device 108, a tenant device 110 (for example a point-of-sale tenant device 110), and third-party servers 112. The third-party servers 112 may be accessed and operated by a third-party data analyzer 114 (e.g., a “big data” company), for example. The third-party servers 112 host third-party applications 116.

The client device 108 is accessed by a user 118 and processes operations and applications (e.g., a browser application, or commercial platform) sourced from or associated with a tenant 120. Where applicable in context, the user 118 may also be referred to as a client, a customer, a consumer, or a tenant patient in some examples herein. Where applicable in context, the tenant 120 may also be referred to as a service provider, a medical practice, or a tenant practice, in some examples herein. A tenant practice may for example operate in a group of networked tenant practices in a multi-tenant network 100. The user 118 may be a tenant patient of the tenant practice, for example. The tenant device 110 is accessed and operated by the tenant 120 to host and process tenant operations and tenant applications 122. In some examples, the multi-tenant network 100 includes a great multiplicity of tenants 120, each communicatively coupled with the licensing and subscription service 106.

The application servers 104 include an API server 124 and a web server 126 which, in turn, facilitate access to several application components 128 that include an expert system 130, a licensing and subscription management system 132, a financial engine system 134, and a data aggregator and anonymizer 136. Each of these components is provided with a respective API, namely an API 138, an API 140, an API 142, and an API 144.

The application components 128 are communicatively coupled to database servers 146 which in turn facilitate access to one or more databases 148.

In an example scenario, a tenant 120 (e.g., a medical practice) may wish to provide offerings (e.g., products or services) to a user 118 (e.g., a patient of the medical practice), either as a once-off/one-time delivery or as part of a subscription plan which has a recurrence. In this example, the medical practice, i.e., tenant 120, may also wish to provide the patient, i.e., user 118 with the option of paying for a health product or consultation as a once-off payment, as a subscription payment, or as a combination of a once off payment and a subscription payment.

At a high level, the expert system 130 operates to enable an expert in a particular vertical (e.g., the medical practice or tenant 120) to its patients or users 118. An expert system 130 is accordingly specifically constructed and programmed for the creation of a plan for the delivery of a specific product or service in a particular product or service vertical. The expert system 130 may also assist to define and manage a licensing plan for a tenant 120 involving a tenant-configurable practice license fee based on a selection of a number of invokable tenant-selectable features of an interaction platform described further below.

The licensing and subscription management system 132 is responsible for the automated management of a plan (which may or may not include any number of subscriptions to products or services, or licensing fees).

The financial engine system 134 is responsible for communicating financing opportunities related to a plan to one or more financiers (e.g., who may operate as a provider, or who may be a third party accessing the financial engine system 134 via the third-party applications 116).

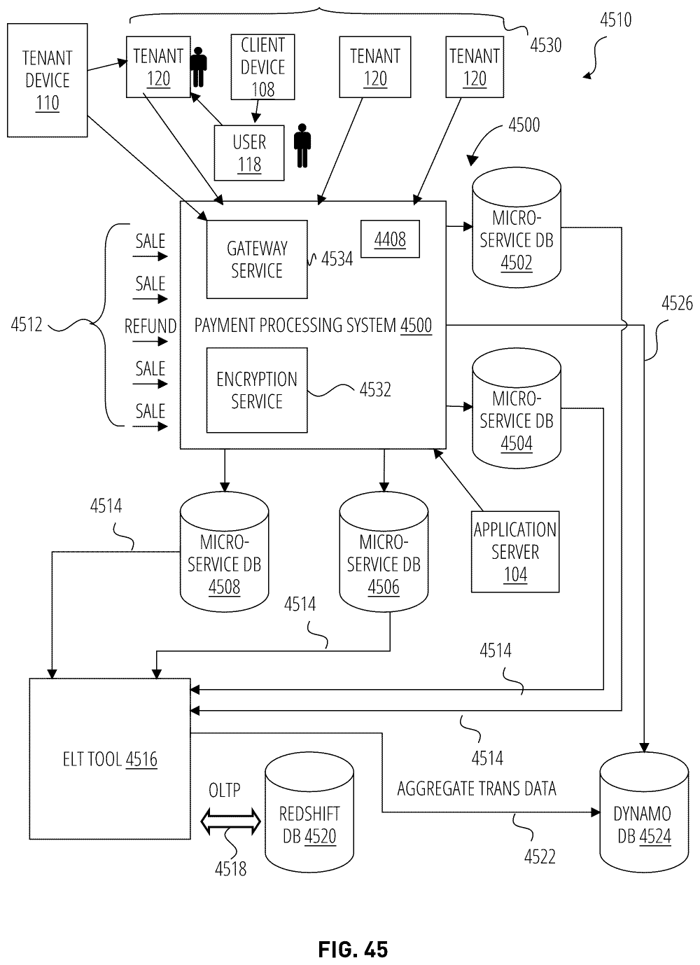

In some examples, the financial engine system 134 may include or be connected to a payment processing system 4500 discussed further below in relation to FIG. 45. The payment processing system 4500 is responsible for operations relating to card present payment deduplication. More specifically, but not by way of limitation, some examples include systems, methods and media for issuing a user alert when a potential duplicate payment is detected.

Some examples herein generate an alert based on a detection that multiple payments are being issued for the same purchase in order to prevent multiple payments being collected for the same purchase. Examples thus seek to provide a technical solution assisting users to prevent re-running multiple payments for the same purchase, either inadvertently or due to system glitches.

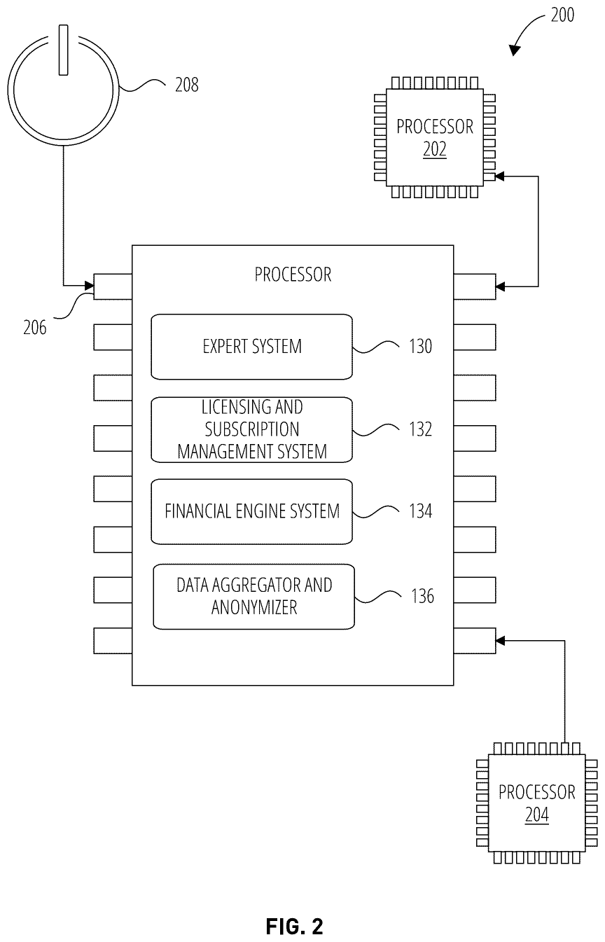

FIG. 2 is a diagrammatic representation of a processing environment 200, which includes a processor 202, a processor 204, and a processor 206 (e.g., a GPU, CPU, or combination thereof). The processor 206 is shown to be coupled to a power source 208, and to include (either permanently configured or temporarily instantiated) modules, namely the expert system 130, the licensing and subscription management system 132, the financial engine system 134, and the data aggregator and anonymizer 136. The expert system 130 operationally supports a guided process for the selection of products or services, as well as the attributes of such products and services (e.g., quantity (units), a frequency of delivery and number of deliveries), to include in a subscription.

The licensing and subscription management system 132 operationally calculates and presents information relating to overall options related to a subscription for bundled purchase, a license fee for example, a tenant-configurable practice license fee for bundled platform features selected from a suite of platform features described further below. The financial engine system 134 operationally allows third parties (e.g., lenders) to view financing opportunities and accept or reject such financing opportunities for subscriptions (or bundles of subscriptions) and license fees generated by the licensing and subscription management system 132.

As illustrated, the processor 206 is communicatively coupled to both the processor 202 and processor 204 and receives data from the processor 202, as well as data from the processor 204. Each of the processor 206, processor 202, and processor 204 may host one or more of an expert system 130, a licensing and subscription management system 132, a financial engine system 134, and a data aggregator and anonymizer 136.

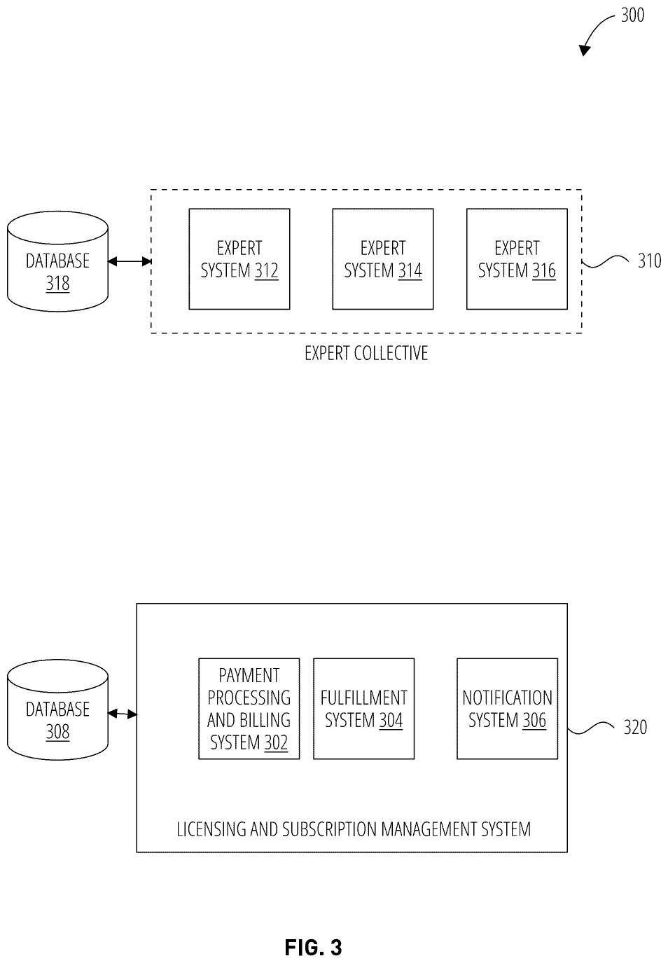

FIG. 3 illustrates various sub-components of a licensing and subscription management system 320, namely a payment processing and billing system 302, a fulfillment system 304, and a notification system 306. The payment processing and billing system 302 is operationally responsible for the processing of payments and issuing of invoices/bills. The fulfillment system 304 communicates with third parties for the shipping of goods, when appropriate, as well as with service providers to record the delivery of goods and services to a customer. The notification system 306 operationally provides notifications to both customers and service providers regarding upcoming fulfillment events, as well as other delivery-related events.

The licensing and subscription management system 320 is also communicatively coupled to a database 308 to both store and retrieve data needed by each of the payment processing and billing system 302, the fulfillment system 304 and the notification system 306. The fulfillment system 304 creates and tracks the fulfillment or delivery of a service or a product. For example, for a service, the fulfillment system 304 records what was rendered or provided (e.g., what, how much, when, value) and uses the notification system 306 to remind users of appointments for a follow-up service. For products, the fulfillment system 304 issues orders, tracks shipping and delivery, in addition to tracking what was rendered and provided.

The notification system 306 is a messaging system that uses different media or messaging channels (e.g., email, text, push notification, etc.) to alert customers, providers (e.g., practices) and operations of different events.

FIG. 3 also illustrates that a licensing and subscription management system 320 may include an expert collective 310 comprising respective and distinct expert systems, namely an expert system 312, an expert system 314 and an expert system 316. Each of the expert systems may be dedicated to a specific vertical and provide a guided process for the creation of license fees for tenants, and subscriptions and plans for patients in that vertical. For example, the expert system 312 may be dedicated to a cosmetics and beauty care vertical, the expert system 314 may be dedicated to a treatment vertical, and the expert system 316 may be dedicated to a nutrition vertical. Each of the expert systems within the expert collective 310 may furthermore communicatively coupled, and have access, to a respective database 318.

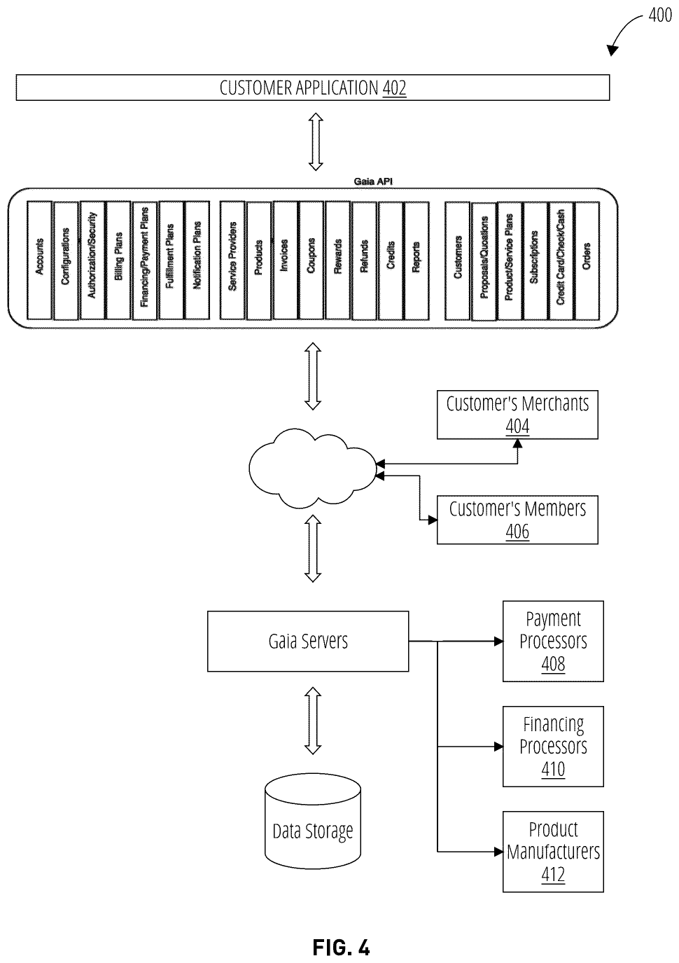

FIG. 4 is a block diagram illustrating a licensing and subscription management system 400 and shows further details for a specific example embodiment. The licensing and subscription management system 400 includes a customer application 402 that, via the API server 124 and the communications network 102, accesses the application component 128. The API server 124 is shown to support many functions provided by the application component 128, using data store to and retrieved from the database 148.

The customer application 402, via the API server 124 and the communications network 102, is also able to access customer's merchant 404 and customer's member 406. The application component 128 is also shown to exchange information and data with payment processors 408, financing processors 410 and product manufacturers 412.

The licensing and subscription management system 400 is, in one example embodiment, a cloud-based e-commerce solution built for developers to streamline and shorten the time to market of any e-commerce system that implements a variety of tenant licensing fees and arrangements, subscription models, quotations, recurring billings, electronic payments, order financing, order fulfillment, loyalty program, and notifications. The licensing and subscription management system 400 provides a rich set application programming interface (API) for developers to seamlessly integrate with their own systems. Modules and their APIs that developers can use to customize the licensing and subscription management system 400 to meet their own needs are as follows:
Accounts: primary account management and authorization.
Billing Plans: billing plan cycle options.
Financing/Payment Plans: members payments and financing options.
Fulfillment Plans: order fulfillment process.
Notification Plans: upcoming product/service notifications.
Service Providers: service providers information and configurations.
Products: products/services configuration.
Invoices: members' invoices and invoice line items.
Refunds: members' refunds management.
Credits: members' credits management.
Reports: analytical data on membership, financials, etc.
Coupons: coupons management.
Rewards: loyalty reward program for membership.
Customers: members management.
Product/service Plans: members' product/service plans management.
Proposals/Quotations: proposals and quotations.
Subscriptions: members' subscription configuration and management.
Credit Card/Check/Cash: member's credit card/check/and cash management.
Sample Data FlowRegister a business account with the licensing and subscription management system 400.
AccountResponse account=createAccount(AccountRequest request) Creates a treatment plan for members that all subscribed services are paid on the same date, the same invoice on a monthly basis.
BillingPlanResponse billingPlan=createBillingPlan(BillingPlanRequest request) Create a one-time payment plan for its subscribers.
PaymentPlanResponse paymentPlan=createPaymentPlan(PaymentPlanRequest request) Create a recurring payment plan for its subscribers. Request Ex: {“name: “Monthly Payment”, payment_gateway: gateway_id, payment_count: 0, . . . });
Create some fulfillment plans (1 month, 2 month, . . . , 12 months) for providers to useFulfillmentPlanResponse fulfillmentPlan1=createFulfillmentPlan(FulfillmentPlanRequest request)
Create some notification plans for providers to use for any subscription's order.
NotificationPlanResponse notificationPlan1=createNotificationPlan(NotificationPlanRequest request)
Create a providerProviderResponse response=API.createProvider(new ProviderRequest( ))
Create coupons from own product catalog for its members.
CouponRequest couponRequest=new CouponRequest( )Create products for its members.
ProductResponse product=createProduct(ProductRequest request)
Registers a new memberCustomerResponse customerResponse=API.createCustomer(customerRequest);
Add CC to a member
CardResponse cardResponse=API.createCard(cardRequest); String cardId=cardResponse.apiData.card.getCardId( );
Create a treatment plan for a member.
SubscriptionPlanResponse subscriptionPlanResponse=API.createSubscriptionPlan(subscriptionPlanRequest);
Create different subscriptions for a member.
SubscriptionResponse subscriptionResponse=API.createSubscription(subscriptionRequest);
Get pending Invoice of a subscription plan.
InvoiceResponse invoiceResponse=API.listInvoices(invoiceRequest); Charge a pending invoice of a subscription plan (Transaction)
TransactionResponse=API.chargeInvoice(transactionRequest);
Get member's upcoming order fulfillment under a subscription planorder list=list_order({“subscription_plan_id”: “pla_9473c93”, “filter”: “pending”})
Updateexpert updates member's order fulfillment; i.e. confirmed, fulfilled, etc.status=update_order({“order_id”: “or_9473c93”, “status”: “completed”}

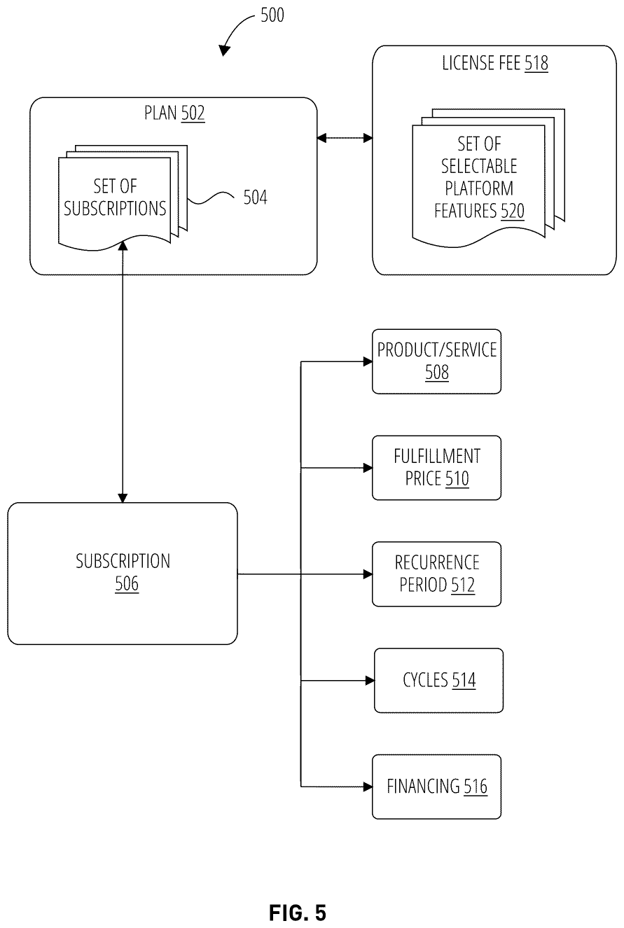

FIG. 5 is a diagrammatic representation of a data architecture 500 created using and maintained by the licensing and subscription management system 320. A plan 502 includes a set of subscriptions 504. Each subscription 506 of the set of subscriptions 504 is for a product or service and has several attributes, a subset of which is shown in FIG. 5. Specifically, each subscription 506 relates to a specific product/service 508, has a fulfillment price 510, and a recurrence period 512. With respect to the recurrence period 512, a subscription 506 has some time period after which the subscription 506 recurs, e.g., must again be fulfilled. A subscription 506 may furthermore have a specified number of cycles 514 and may occur indefinitely or terminate after the specified number of the cycles 514.

A subscription 506 furthermore has associated financing 516. A subscription 506 may be financed via a loan or via a service provider directly as part of the service provider's subscription business. Alternatively, a subscription 506 may be fulfilled at the time of ordering.

Attributes of the subscription 506 may be managed by customers in some cases. For example, the cycles 514 may be modified or changed by a customer using the client 150 in order to interact with the licensing and subscription management system 320.

A specific subscription 506 may furthermore be executed independently of any other subscriptions included in a set of subscriptions 504, with the exception that billing is aggregated to a single payment at predetermined intervals (e.g., once a month).

A plan 502 may also include a license fee 518 (also referred to as a tenant-configurable practice license fee) based on a set of selectable platform features 520 selected by a tenant 120 using the licensing and subscription management system 132 or licensing and subscription management system 320 in a multi-tenant network 100.

A plan 502 for the delivery of service may be constructed or defined with the help of an expert (e.g., a physician or doctor) using an appropriate expert system 312, and performance/delivery of a subscription 506 of the plan 502 may be fulfilled at the expert's place of business (e.g., the doctors practice). A plan 502 for the delivery of a product may be fulfilled by shipment from a third party.

To facilitate financing (e.g., a loan as part of the financing 516) in near real-time, the licensing and subscription management system 320 is communicatively coupled to the financial engine system 134 to enable the licensing and subscription management system 320 digitally to communicate details about a particular subscription 506 or set of subscriptions 504 or license fee 518 or set of selectable platform features 520 to the financial engine system 134. Financiers then access the financial engine system 134 (e.g., using a third-party application 116) to optionally accept a financing offer relating to a particular set of subscriptions 504 or subscription 506, or license fee 518 or set of selectable platform features 520.

This facilitation of financing by a financier happens in near real-time for a tenant 120 or user 118. In a typical scenario, a customer is physically present at the checkout counter of a service provider. To this end, the financial engine system 134 operationally aggregates accepted financing and rates, refusals and regular recurring subscriptions amounts to create a quote for a total monthly price for all subscriptions within a set of subscriptions 504.

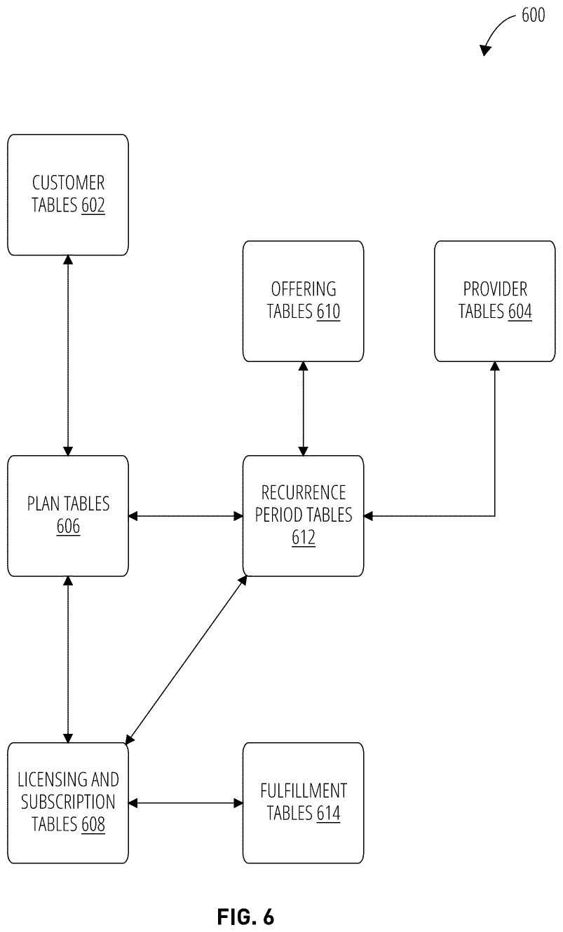

FIG. 6 is a block diagram illustrating a data architecture 600, according to some example embodiments. The data architecture 600 is realized and stored within the database 148. Customer tables 602 store records for customers (e.g., the consumer or user 118) of various service providers, each service provider, in turn, being recorded within provider tables 604. A customer record within the customer tables 602 may be associated with a plan 502 for which a record exists within plan tables 606. Each plan 502 within the plan tables 606 may be associated with a set of subscriptions 504, records for which exist within the licensing and subscription tables 608. Offering tables 610 maintain records for each product/service 508 (as examples of offerings), and each subscription 506 has a specified cycle 514 within recurrence period tables 612. A fulfillment price 510 associated with a particular subscription 506 is also stored within respective records of the recurrence period tables 612.

Fulfillment records (e.g., indicating and recording whether a particular subscription 506 has been fulfilled) are stored within fulfillment tables 614.

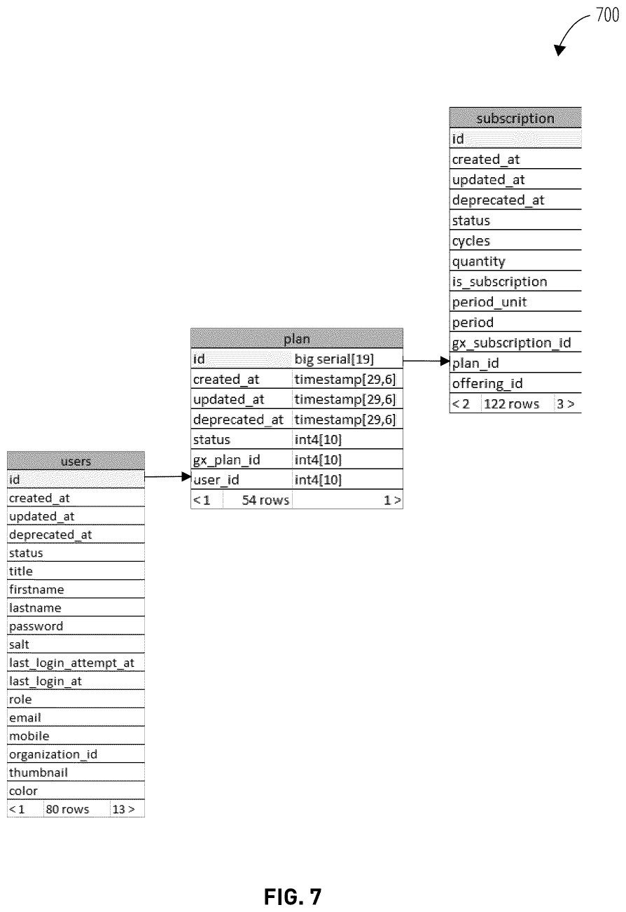

FIG. 7 is a table diagram 700 illustrating further details of data, according to some example embodiments, stored within the various tables discussed above with reference to FIG. 6.

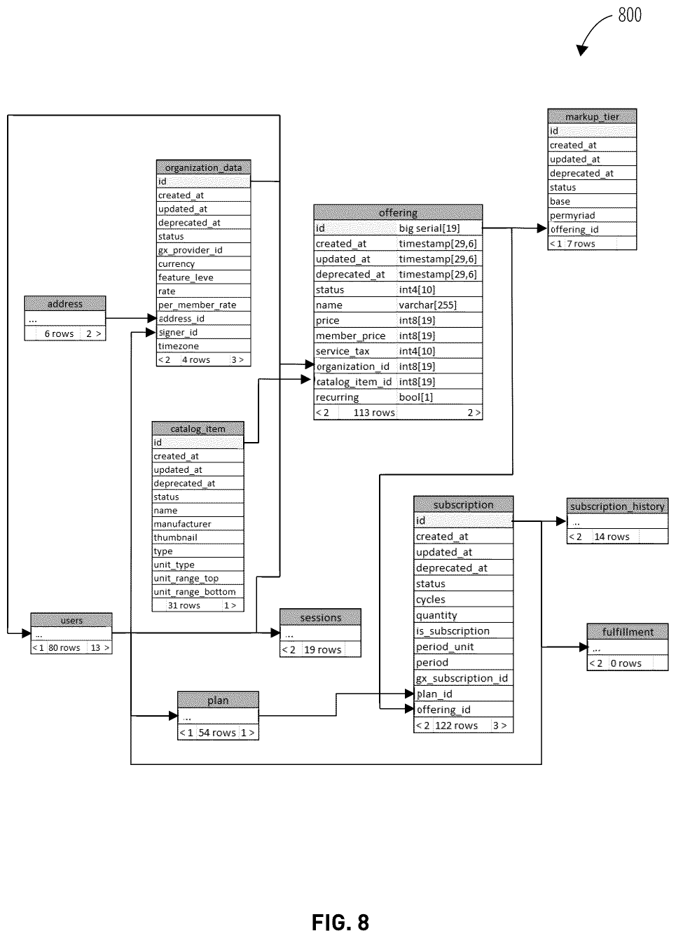

FIG. 8 is a table diagram 800 illustrating further details of data, according to some example embodiments, stored within the various tables discussed above with reference to FIG. 6.

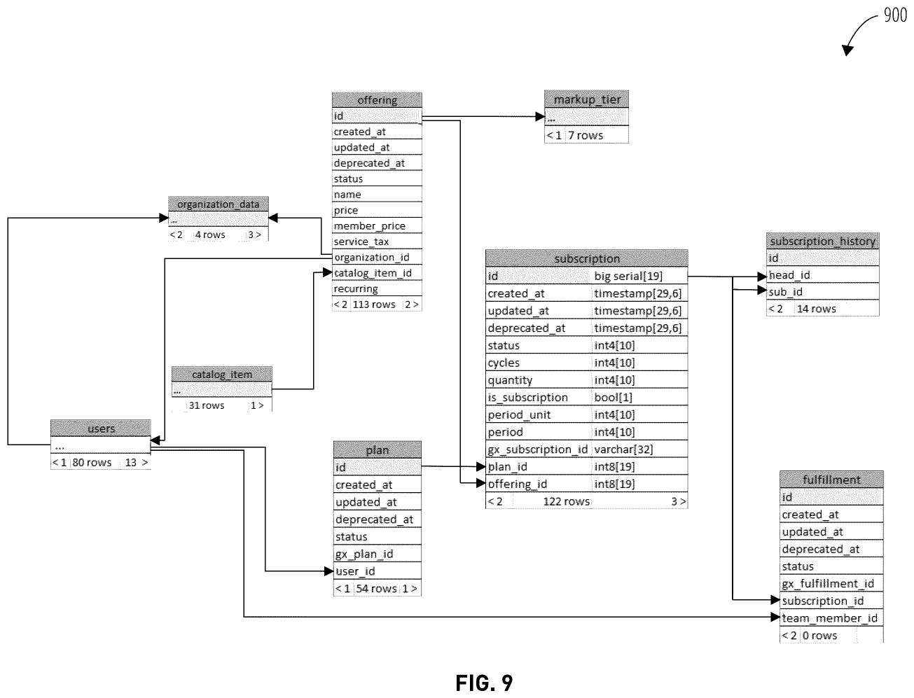

FIG. 9 is a table diagram 900 illustrating further details of data, according to some example embodiments, stored within the various tables discussed above with reference to FIG. 6.

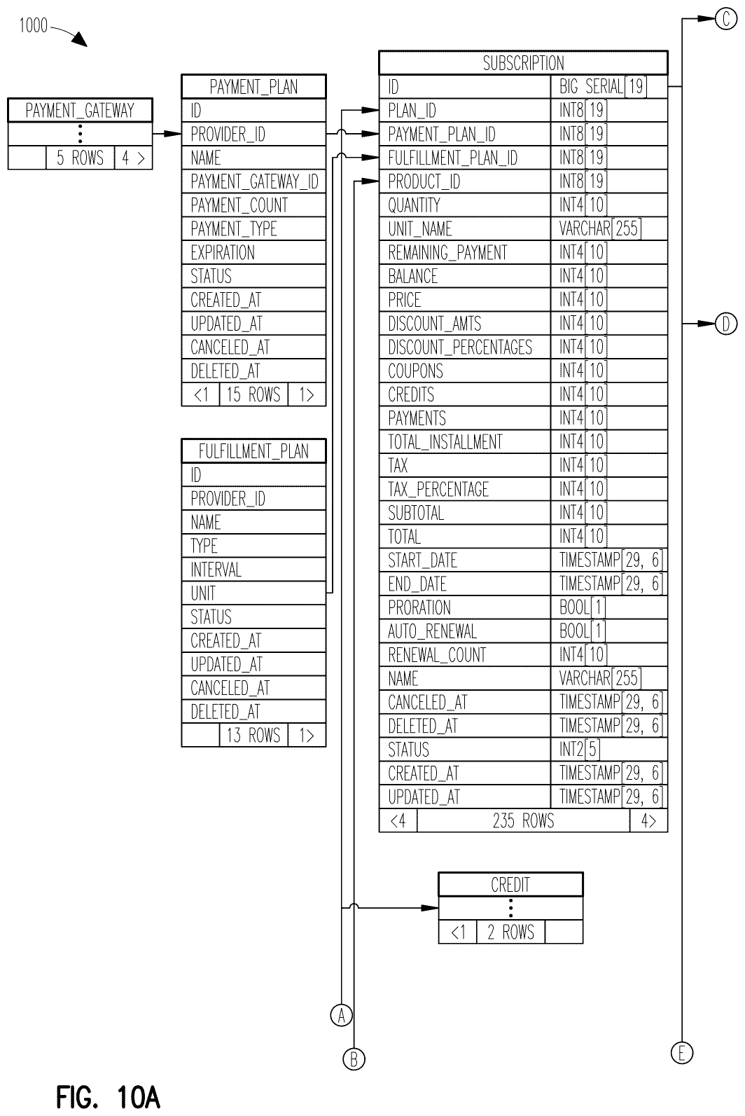

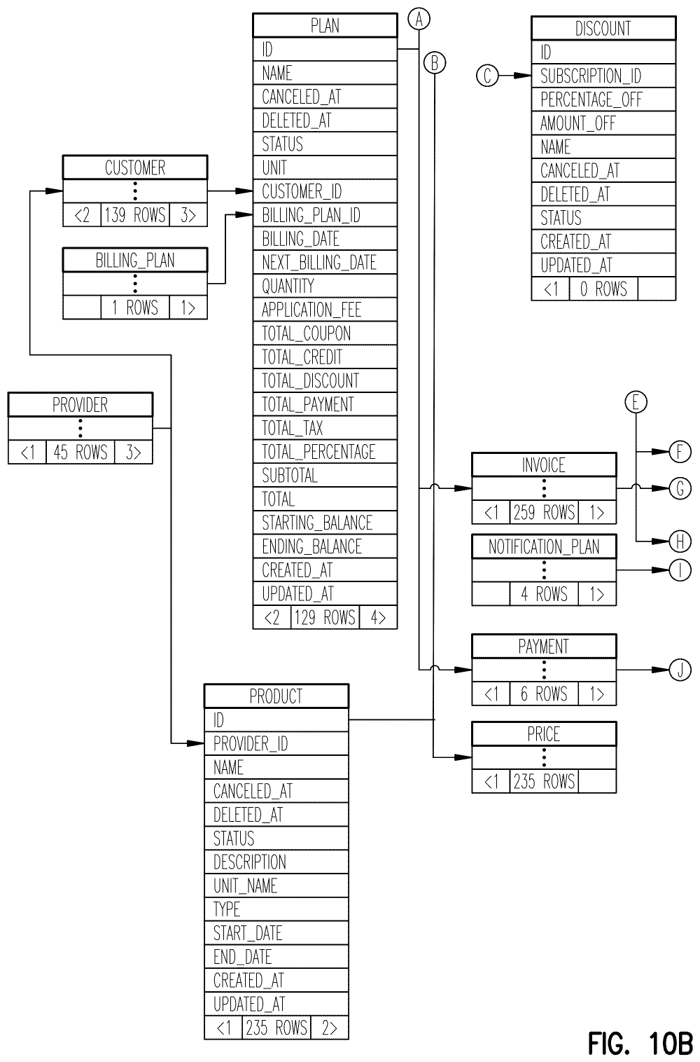

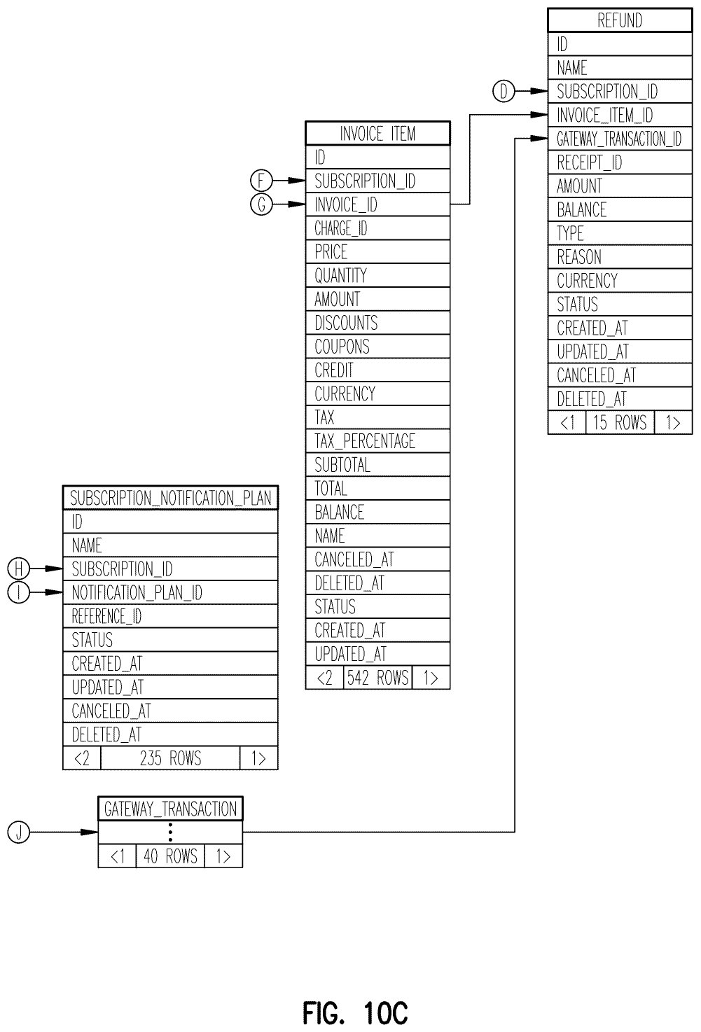

FIG. 10 is a table diagram 1000 illustrating further details of data, according to some example embodiments, stored within the various tables discussed above with reference to FIG. 6.

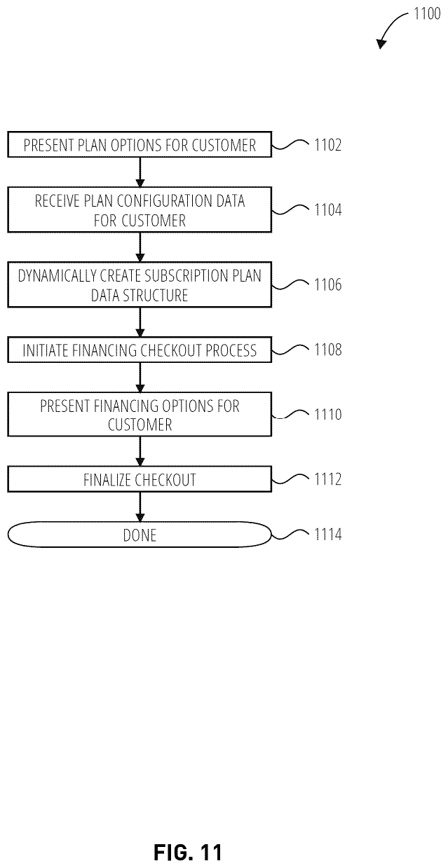

FIG. 11 is a flowchart illustrating a method 1100, according to some example embodiments, to create a subscription plan data structure and to facilitate financing of the subscription plan reflected in the data structure. Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

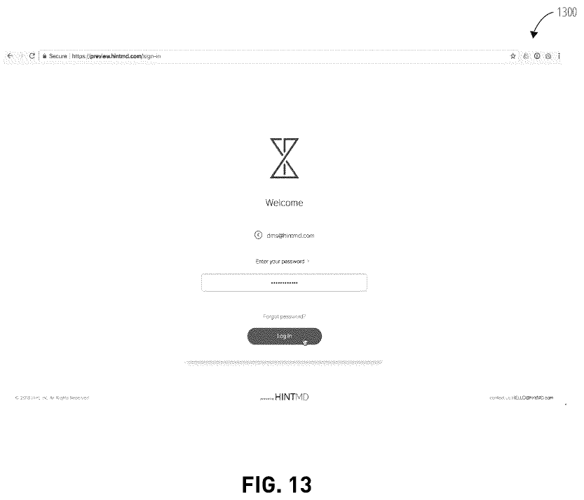

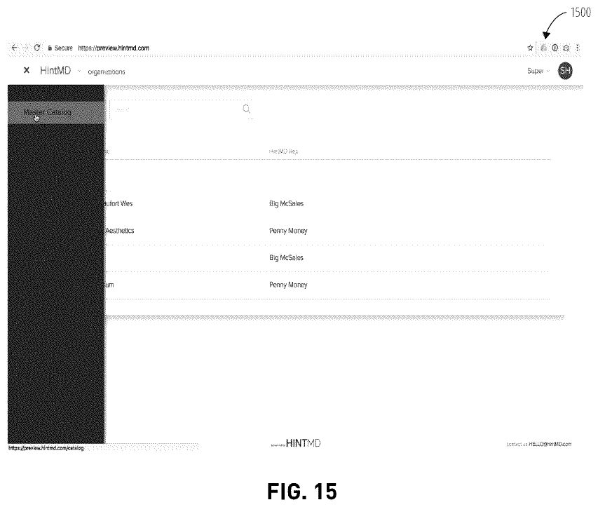

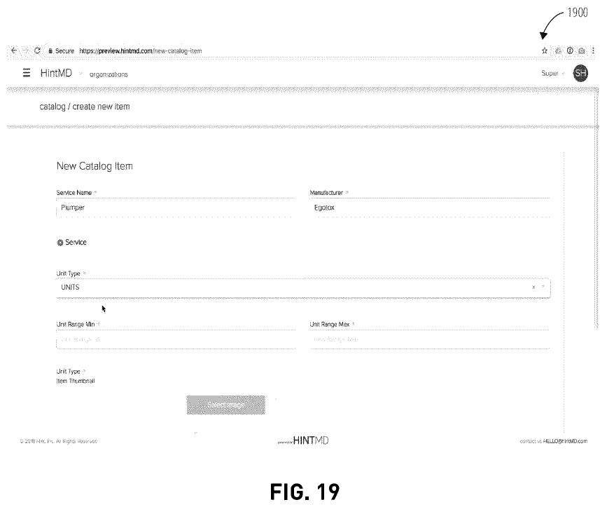

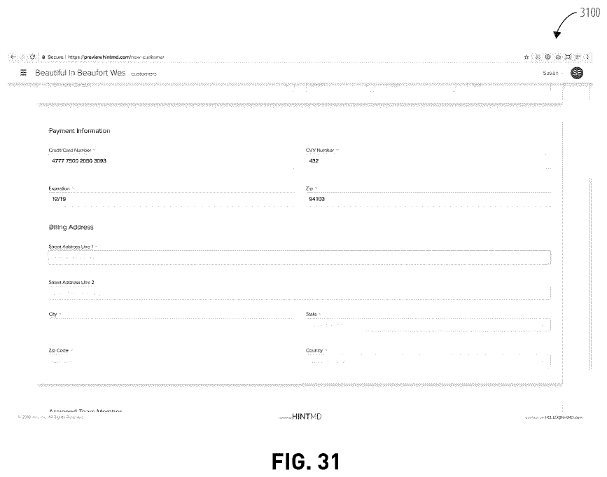

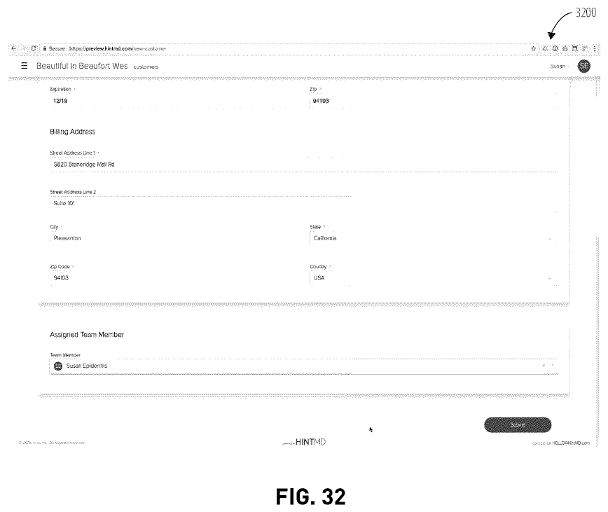

The method 1100 commences at operation 1102 with the presentation of plan options to a customer. In one embodiment, the presentation may be made via user interfaces on which an expert (e.g., a cosmetic physician) and the customer collaborate. The presentation may accordingly be done via interfaces that are generated and communicated from an appropriate expert system 124, via a web server 122, to a client device 108 being operated by the expert. FIG. 13-FIG. 41 illustrate examples of such user interfaces.

At operation 1104, the licensing and subscription management system 128 receives plan configuration data from the expert system 124, the plan configuration data having been received from the customer at operation 1104 and in response to the presentation of plan options at operation 1102. The plan configuration data, in some example embodiments, include the data described above with reference to FIG. 5 through FIG. 10.

At operation 1106, the licensing and subscription management system 128 proceeds to automatically and dynamically create a subscription plan data structure, such as that described above with reference to FIG. 5 through FIG. 10.

At operation 1108, the licensing and subscription management system 128 initiates a financing checkout process by communicating pertinent details of a particular plan 502 of the financial exchange 130. Specifically, the licensing and subscription management system 128 provides the following information to the financial exchange 130:
Information about the service provider (e.g., a medical practice) that provides the services;
Information about the customer (e.g., personal information such as a Social Security number (SSN) or driver's license number (DLN)) and financial history summary of the financial relationship between the customer and the service provider (e.g., including a financial history rating based on experience); and

Details of the plan including an array of subscriptions.

The financial exchange 130 responds with a number of financing offers containing:
A list of subscriptions in the offer; and
Terms for the offer (e.g., interest rate, pay-off time, down payment, other financing items)

The licensing and subscription management system 128 will consider these and pick zero or more to offer the customer using pre-defined business rules. These business rules may specify:
Finance everything or nothing
Prefer fewer offers
Prefer lower offers
Provider finances unclaimed subscriptions

The financing checkout process is facilitated in real time as a customer may be physically present at the location of an expert (e.g., a physician). As described above, the financial exchange 130 then presents financing options to potential financiers (e.g., various third parties or to the expert or service provider), to enable real-time decision-making by the potential financiers.

At operation 1110, the financial exchange 130, having received acceptances or rejections of financing offers from the potential financiers, communicates these financing options back to the licensing and subscription management system 128, which in turn presents them, via the expert system 124 to the customer. The customer, at operation 1112, then elects to accept or reject the financing offers and finalizes the checkout process.

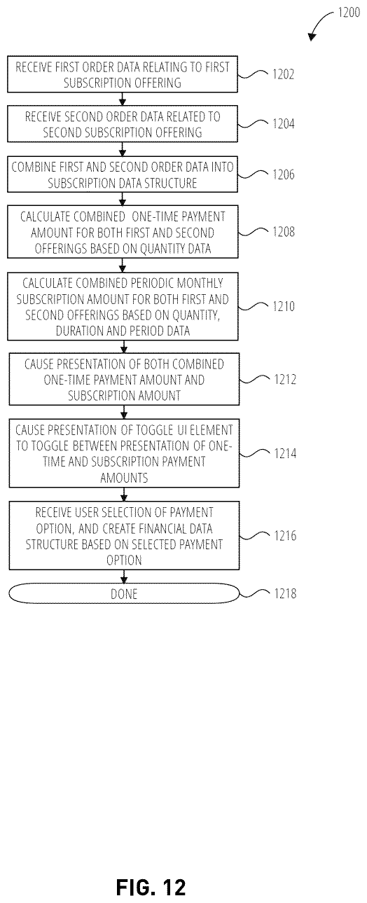

FIG. 12 is a flowchart illustrating a method, according to some example embodiments, of presenting combined one-time payment and subscription payment information to a user of a licensing and subscription management system.

The method 1200 commences at operation 1202 with the receipt, by the licensing and subscription management system 128, of order data relating to a first subscription. The order data is inputted into an expert system 124 by a user (e.g., a customer in collaboration with expert, or by an expert alone) and specifies various attributes with respect to a subscription (e.g., a product or service) that is being presented for purchase to a customer. Attributes of a subscription that may be included within the order data are reflected in the licensing and subscription table, offering table and catalog_item table of FIG. 8. As shown in FIG. 8, a particular subscription may also inherit various attributes of an offering in the offering table and a catalog item in the catalog_item table.

At operation 1204, the licensing and subscription management system 128 may receive further order data relating to a second subscription that a particular customer wishes to purchase. Again, this further order data may be entered into the expert system 124 by a user, and specifies various attributes with respect to a second subscription.

Together, the first and second subscription may constitute a bundle of products and/or services that the customer wishes to purchase using either a one-time payment or a subscription payment plan.

After receiving the order data from a customer at operation 1202 and operation 1204, the expert system 124 operationally presents several subscription choices to a customer. The examples discussed herein with respect to subsequent figures show a process in which various cosmetic and/or beauty products and services are presented, by an appropriate expert system 124, to a user for selection. Multiple attributes of these subscriptions are specified in the order data received at operation 1202 and operation 1204, including attributes such as quantity (e.g., number of units), frequency or recurrence period (e.g., the period of time between the delivery of the respective quantity of products or services), and duration or cycles (e.g., the number of deliveries of the respective quantity or services).

At operation 1206, the licensing and subscription management system 128 combines the first and second order data into a subscription data structure (e.g., see FIG. 7), which is stored in a database and presented via a user interface to a user (e.g., an expert or consumer).

At operation 1208, the licensing and subscription management system 128 calculates a combined one-time payment amount for both the first and second subscriptions, based on quantity data included in the respective first and second order data.

At operation 1210, the licensing and subscription management system 128 calculates combined periodic monthly subscription payment amounts for both first and second offerings, based on the quantity, recurrence, and duration information included in both the first and second order data.

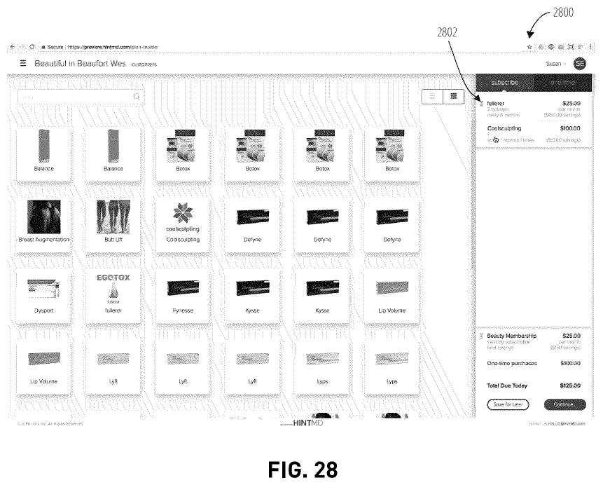

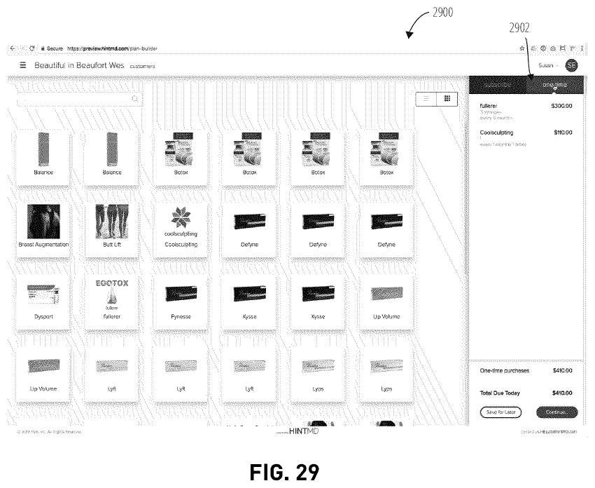

At operation 1212, the licensing and subscription management system 128 causes presentation of both the combined one-time payment amount, and the combined periodic monthly subscription payment amount, within a single user interface (see FIG. 28 and FIG. 29).

The user interface includes a first user element to present the combined one-time payment amount (FIG. 29) and a second user element to present the combined monthly subscription payment amount (FIG. 28). The user interface further includes a toggle feature or element (also referred to herein as a second toggle feature) to enable a user to toggle between the presentations of the first user interface element (presenting the combined one-time payment amount) and the second user interface element (presenting the combined monthly subscription payment amount). By presenting this toggle feature, the user interface conveniently allows a user (e.g., an expert or consumer) to compare and contrast payment options in a convenient way, while maintaining the ability of the user to select one of these options without navigating away from the primary interface within which the first and second user interface elements are contained.

While the combination of only first and second subscription offerings has been described above for the sake of clarity, multiple offerings subscriptions can be included in the subscription data structure. For example, third order data, relating to a third subscription offering, may be received via a user interface of an expert system 124 and communicated to the licensing and subscription management system 128. The licensing and subscription management system 128 may then combine the first, second and third order data into the subscription data structure.

At operation 1216, the licensing and subscription management system 128 receives the user selection of one of the payment options (e.g., a one-time payment or subscription payment), and dynamically creates a financial data structure related to the subscription bundle, based on the selected payment option. The financial data structure, which includes the subscription plan a data structure discussed above at operation 1106, is then used to initiate the financial checkout process (operation 1108).

The method 1200 then terminates at done block 1218.

FIG. 13 through FIG. 21 show a sequence of user interfaces in a tenant patient view flow that a user (e.g., a patient, an expert, or a supplier) may be presented via a licensing and subscription management system, and which the user may manipulate to create and update a master catalog of subscription offerings (e.g., products or services).

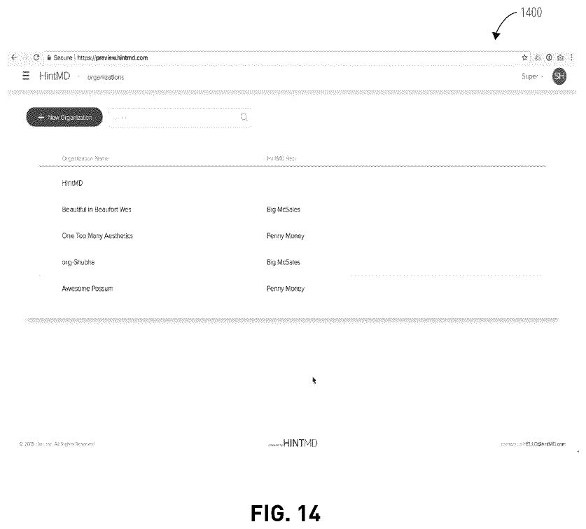

A master catalog is a catalog of brand products and services that a specific supplier can choose from and modify to populate a user-specific and customized catalog. Following a login operation (FIG. 13) and selection of a particular organization (FIG. 14), a user is presented with a “new catalog item creation” sequence.

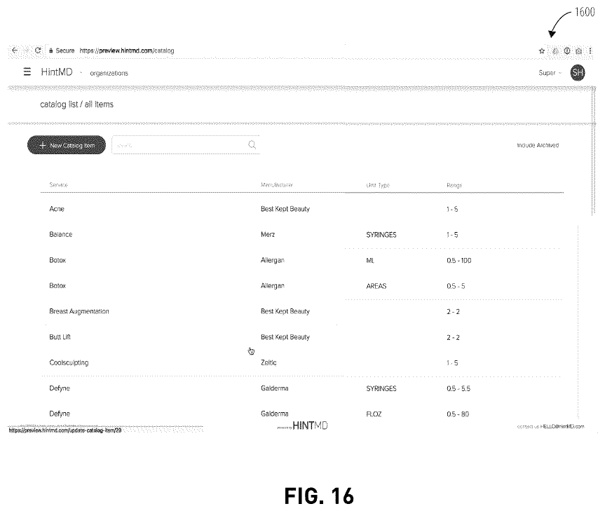

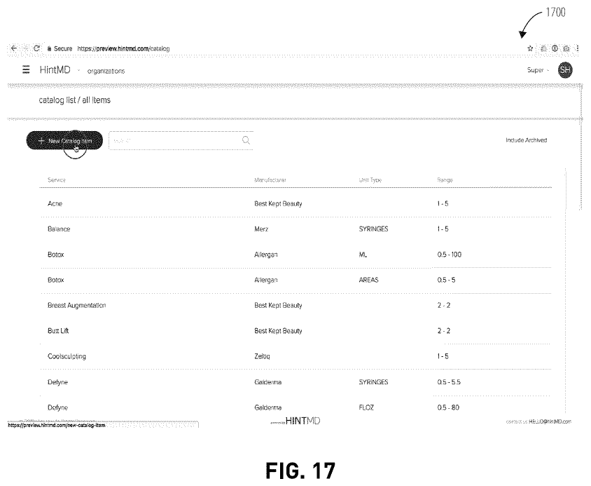

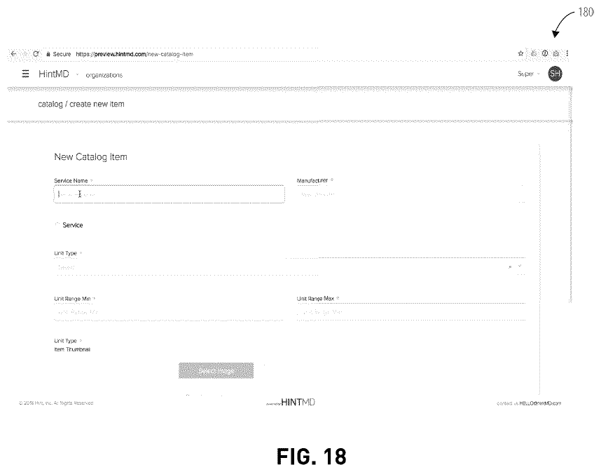

The creation of a new catalog item commences with the selection of the “create new item” menu item (FIG. 16-FIG. 17), responsive to which the user is presented with an interface (FIG. 18) into which the user inputs a service (or product) name, as well as a manufacturer designation. A user-selectable radio button enables the user to identify the catalog item as being a service (as opposed to the default of a product). In a different embodiment, a “product” radio button may be presented to a user to enable the user to designate the catalog item as a product specifically. In yet other embodiments, other type radio buttons may be presented to enable other offering type designations.

A user may then, from a drop-down menu, specify a unit type for the new catalog item (FIG. 18). Example selections from the unit type menu include unitless, units, syringes, etc. A user is then able to specify a minimum and maximum range for the specified unit type, which determines the number of increments displayed on a slider selector interface element presented in a plan creation user interface.

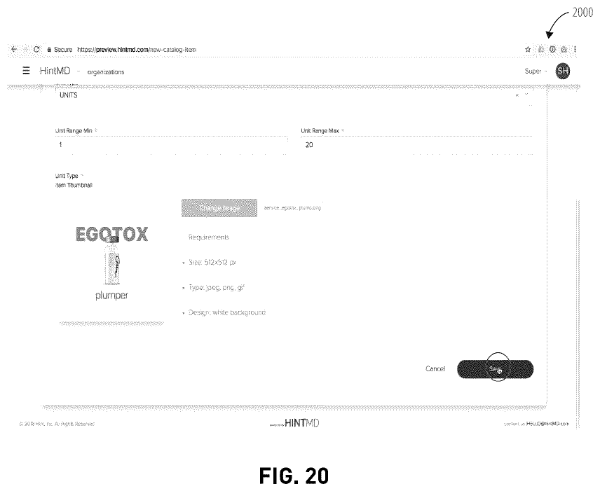

A user then specifies a thumbnail image (FIG. 20) to be displayed for the relevant catalog item (e.g., this may be uploaded from the user's computer or uploaded from a third-party Internet location). The user then selects the “save button” to save the specification for the new catalog item.

The above-described creation of a new catalog item for the master catalog is something that would typically only need to be performed one time to populate the master catalog. A user may furthermore review and edit a newly created master catalog item by selecting a within the “catalog list/all items” user interface.

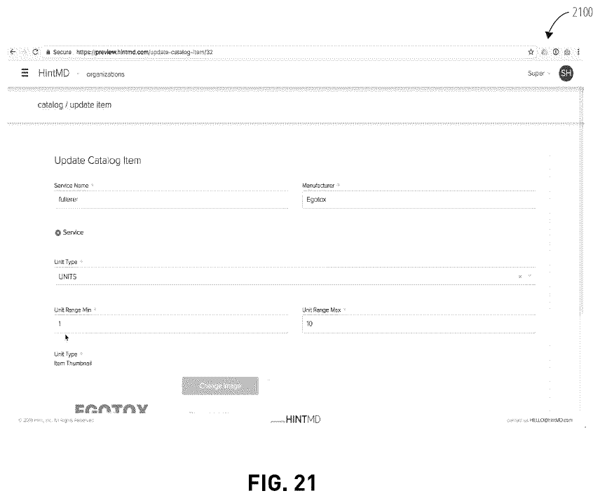

FIG. 21 is a screenshot for user interfaces that enable a user to edit a catalog item, according to some example embodiments. As a first step, the user selects, from the list of master catalog items, a particular catalog item that the user wishes to edit.

Any of the information described above (e.g., the JPEG image, units, etc.) may conveniently be modified. A change or edit made to a single catalog item for a particular brand or manufacturer may, in some embodiments, automatically be propagated to other catalog items from the same brand or manufacturer. For example, a change to the thumbnail image of a particular catalog item from a particular brand may result in the thumbnail images for other catalog items from that same brand of manufacturer also being changed.

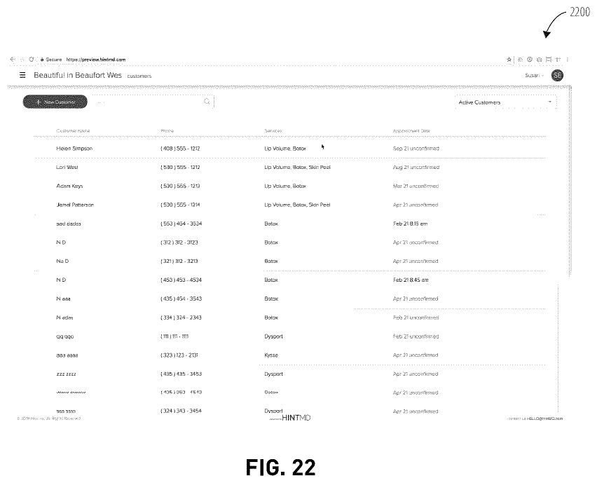

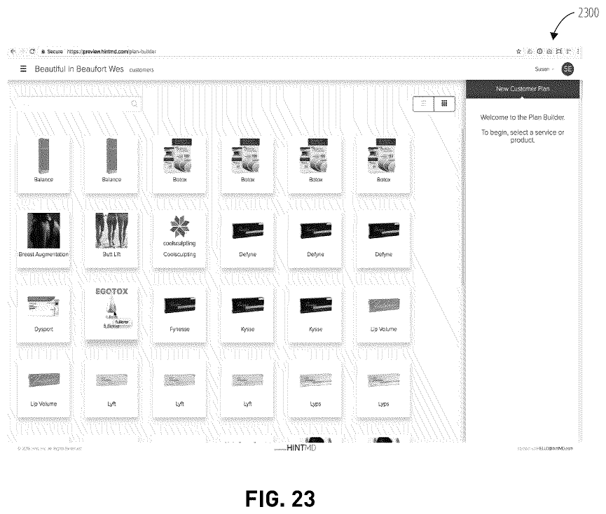

FIG. 22-FIG. 41 are screenshots of user interfaces (as an extension of the tenant patient view, or a separate flow for another user) that may be presented to a user, by an expert system, as part of a new customer creation process. The new customer creation process will in some examples be performed by an expert (e.g., a physician at a cosmetic beauty practice) identified by a name in the top right-hand corner of the interface (e.g., Susan with the practice “Beautiful in Beaufort Wes”). The default view is the customer list, from which the expert can select a “create new customer” icon, which initiates display of a plan builder interface (e.g., the “new customer plan” interface (see FIG. 23).

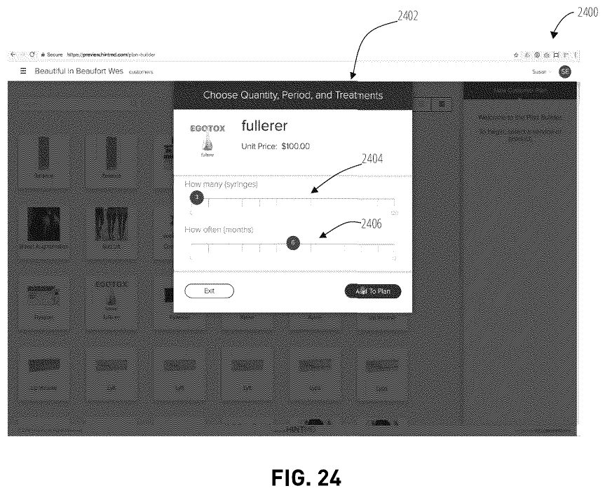

FIG. 23 illustrates a user interface presenting a matrix of user-selectable offering elements, each including a thumbnail image and title that are selectable to add an associated offering to a plan. Selection of a specific offering element invokes an overlaid sub-interface—e.g., a “choose quantity, period and treatments” interface—for the specific offering (e.g., either a product or a service). In the illustrated example of FIG. 24, the product “FULLERER” is selected from the matrix, and an associated slider sub-interface 2402 is presented in an overlaid manner over the primary “matrix” interface. The slider sub-interface 2402 presents a graphical user interface data input element in the form of a respective slider for each of two attributes of the offering, namely a quantity attribute (“how many”), and a recurrence period attribute (“how often’).

Each slider has a series of demarcations or intervals between a minimum value and a specified maximum value specified for the attribute. For example, a quantity slider 2404 has several demarcations representing a number or quantity of offerings that can be provided as part of the plan. Similarly, a recurrence period slider 2406 has a number of demarcations representing the number of months between each scheduled supply/delivery of the offering in terms of the plan.

Each slider also has a movable selection element in the form of a circle or dot, within which is displayed a number representing the value for the attribute that the expert wishes to specify as part of the plan. By sliding the movable selection item to the left and right, the expert is able to specify an input value for the respective attribute. This number is displayed as a numeric value within the movable selection item. Visually, the selection element is empty when located at the 0 value (the default position). Upon user selection, the selection element visually raises from a locked vertical position, to a vertical position just above the slider line. When in the move vertical position, the slider element is movable horizontally left and right along the slider line. The selection element is filled (or otherwise graphically distinguished) as it is moved from the default horizontal position. Further, a number or value is displayed within the selection element to represent the aligned value on the slider line. For example, in FIG. 24, the respective selection elements display the numbers “3” and “6” respectively. Graphically, the selection element drops back down (relative to the selection line) to a locked vertical position on a selected value to complete the value selection process.

As noted above, defining the quantity and frequency of delivery of a product or service offering under subscription plan is tricky and presents technical challenges to a user. This is particularly so where the product or service offering is being subscribed to as a bundle of offerings or services that are all being included within a single subscription plan. For example, defining the quantity and frequency of delivery requires typing numerical data into appropriate fields and then calculating variables to display a monthly cost of the subscription plan. Because the slider sub-interface 2402 is frequently used on a touchscreen tablet device while the customer is watching, there is a need to have a fast friction free device to enter the data.

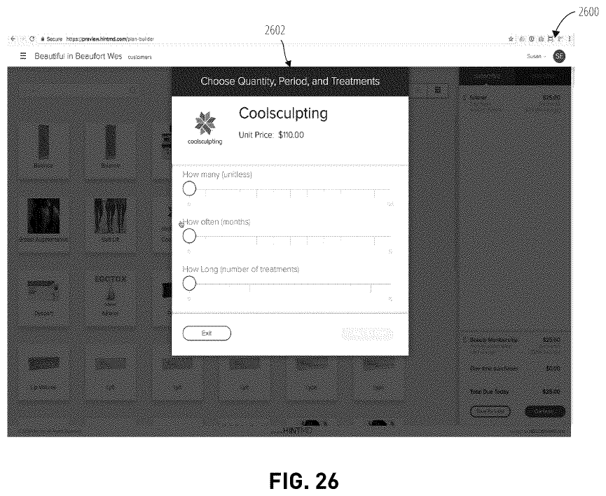

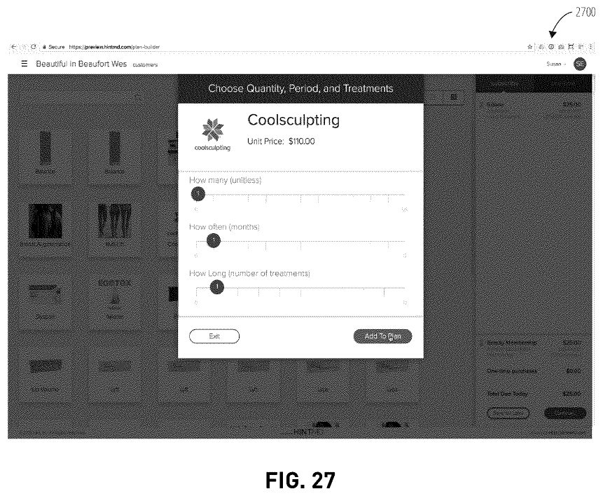

The slider sub-interface 2402 described with reference to FIG. 24 (as well as those illustrated and described with reference to FIG. 26 and FIG. 27) present a user interface that uses sliders to specify input values for subscription variables. In one embodiment, this allows a user (e.g., an expert or a customer) to avoid using the keyboard on touchscreen devices. However, in a further embodiment, for personal computer users who have a keyboard, the slider sub-interface provides fast text entry which is seamlessly integrated into the user interface.

The slider sub-interface 2402 also calculates and displays a monthly (or other periodic) cost dynamically as the respective sliders are manipulated. This function further increases the efficiency of the input and lets the user (e.g., the beauty expert or physician) and customer (e.g., patient) quickly adjust the sliders interactively to arrive at the desired cost.

This tool also allows for a volume discount model, so prices are adjusted accordingly without further interaction from the user. The base price for an offering (e.g., a service or product) is set in an offering table (see FIG. 8). Any number of markup tiers then describe a percentage markup or markdown for a given volume of product. For example:
Offering->Base $100 per unit
Markup_tier[0]->at 10 units, discount 5%
Markup_tier[1]->At 20 units, discount 10%
So 25 units->25×100−10%=$2250

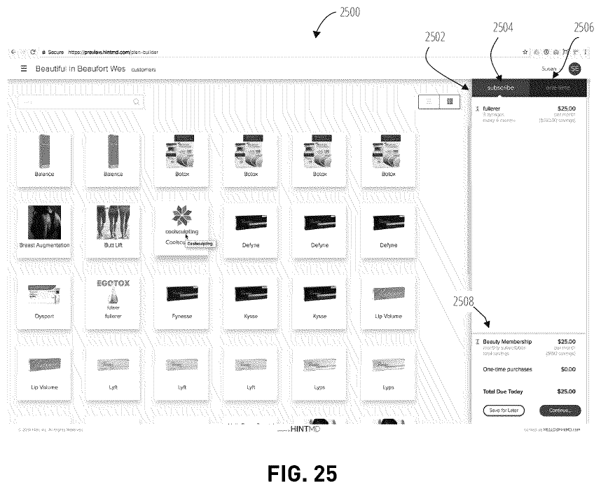

In the illustrated example of FIG. 25, the FULLERER product is added to a cart sub-interface 2502 of the interface on the right. Because the relevant product is identified as a subscription-option product, a subscribe tab 2504 of a toggle element at the top of the cart sub-interface 2502 is flagged or highlighted to reflect that the product is payable by way of a subscription. Specifically, the subscribe tab 2504 indicates that the relevant product is available for a subscription of $25 per month part of a “beauty membership” monthly subscription. On the other hand, should the relevant product have been identified within the master catalog as a one-time purchase only option product, a one-time tab 2506 of the toggle element would not have been highlighted or activated within the ca subsection of the interface.

It will further be noted that the cart sub-interface 2502 includes all details regarding the subscription to the relevant product—e.g., three syringes, delivered every six months, and a subscription cost of $25 per month, with a $150 saving.

A lower part 2508 of the cart sub-interface 2502 provides a summary of offerings within the cart and shows a combined a subscription total of $25 a month, and a combined one-time purchase total of zero dollars, with a total payment due today in order to activate the subscription.

In the illustrated example of FIG. 25, the user may then also select a COOLSCULPTING product from the offering matrix to add to the “cart” or subscription bundle, in the same manner as described above. Specifically, the user selects the relevant product from the matrix activates the sub-interface associated with the COOLSCULPTING product. As shown in FIG. 26, the selection sub-interface 2602 presents three attribute sliders, namely a quantity attribute slider, a recurrence period attribute slider, and a duration attribute slider. By selecting a value of 1 for each of these attributes, the user can specify that this is a one-time purchase of the COOLSCULPTING product (see FIG. 27). User selection of the “add to plan” button then results in the COOLSCULPTING product being added to the cart (e.g., displayed within the cart sub-interface of the interface) (see FIG. 28).

As shown in FIG. 28, it will be noted that there is no “hourglass” indicator displayed next to the data for the COOLSCULPTING product in the cart sub-interface of the interface, thus indicating that this product is not part of the recurring membership (or subscription). Rather, the COOLSCULPTING product is a one-time purchase of $100, as reflected in the summary section of the cart sub-interface. The FULLERER product is however identified by an hourglass indicator 2802 as a subscription offering.

Referring to FIG. 29, should the user wish to pay for both the products in the “cart” as a one-time purchase, a user may select the one-time payment tab 2902 within the toggle element at the top of the cart sub-interface. This toggle element then causes the hourglass indicator adjacent the FULLERER product to disappear, and the summary section is also modified to show a total for the one-time purchases of $410.

In this way, a user (e.g., an expert) can conveniently present both the subscription option by selecting the subscription tab of the toggle element and the one-time payment option by selecting the one-time payment tab of the toggle element. Each of these tabs causes the presentation of the payment information to be updated and displayed in accordance with the selected payment option. A user (e.g., an expert) can thus conveniently communicate payment options to a customer (e.g., at a checkout) without having to make any modification to the content of the cart.

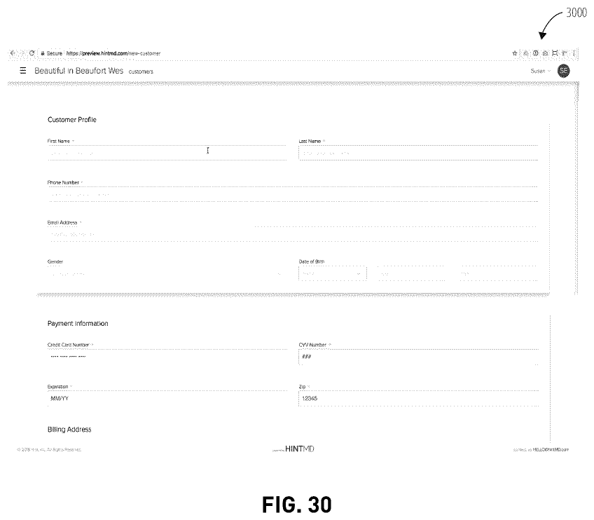

Referring to FIG. 29, if the customer wishes to proceed with the subscription option, a “continue” button on the cart sub-interface is selected, which then invokes a customer sign-up flow and the presentational of corresponding interfaces. As shown in FIG. 30-FIG. 32, the customer sign-up interface includes a customer profile section, a payment information section, and an assigned team member section. The “assigned team member”, in one embodiment, may be the expert that has been responsible for signing up the customer, and the licensing and subscription management system 128 may allocate appropriate credit to the relevant expert for performing the customer sign-up.

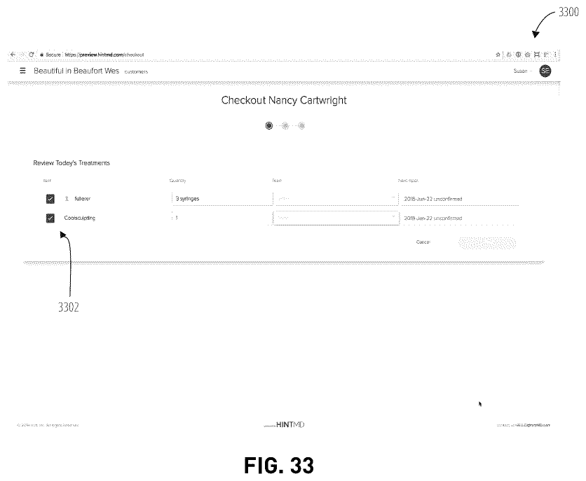

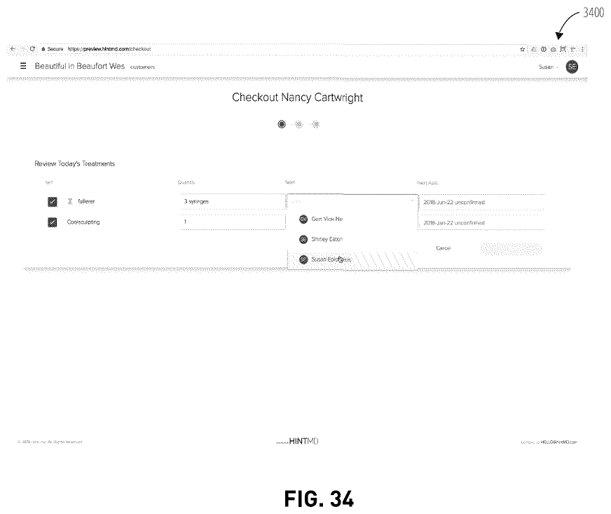

Once the user is satisfied with the customer information, a “submit” button is selected, which then invokes a “review today's treatments” interface (FIG. 33). In the illustrated example, the customer, Nancy Cartwright, has elected to a first treatment on the day of the sign-up. Checkboxes 3302 on the left of the review section are user selectable to indicate and record delivery are the relevant treatments (both products and services) to the customer on the current date. In addition, the quantities of the delivery are recorded within this interface. While the default values are typically pre-populated into the quantity fields of the centers, these values are modifiable in case a deviation from the default quantities occurred. In addition, drop-down menus (see FIG. 34) are provided to enable input all the names of the team members that deliver the product and/or provided the services (again so that these team members may be appropriately compensated or that their performance may be evaluated).

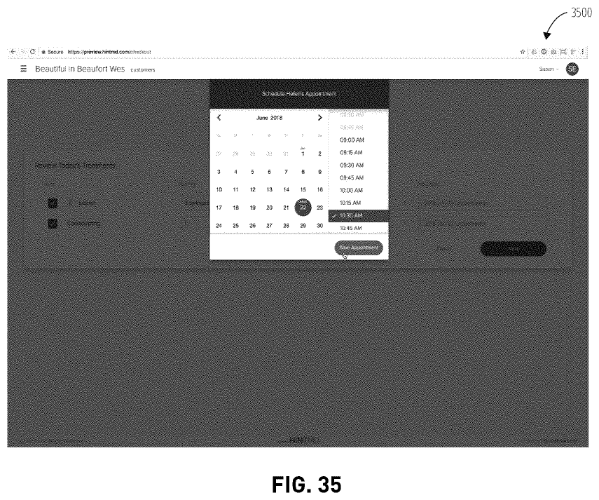

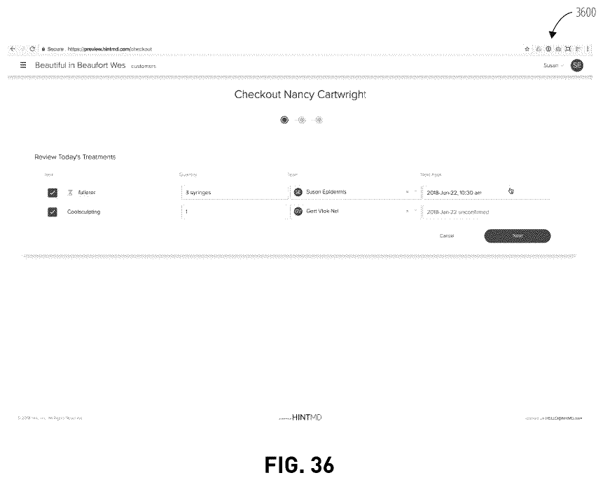

Further, “next appointment” fields for each offering may be populated to include a date for the next appointment (or delivery are an appropriate product and/or service). To this end, a convenient calendar drop-down (see FIG. 35-FIG. 36) may be presented using which of the user can select a date and time for the next appointment for each offering.

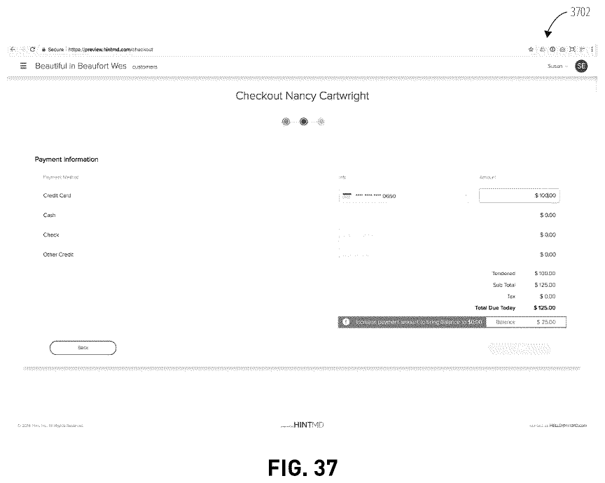

From the offering review interface, the sequence moves on to the payment information interface 3700 (FIG. 37) which is automatically pre-populated with the customer's credit card information extracted from their user profile. Further, the “amount” field is automatically populated with an amount that is due at checkout on a relevant day.

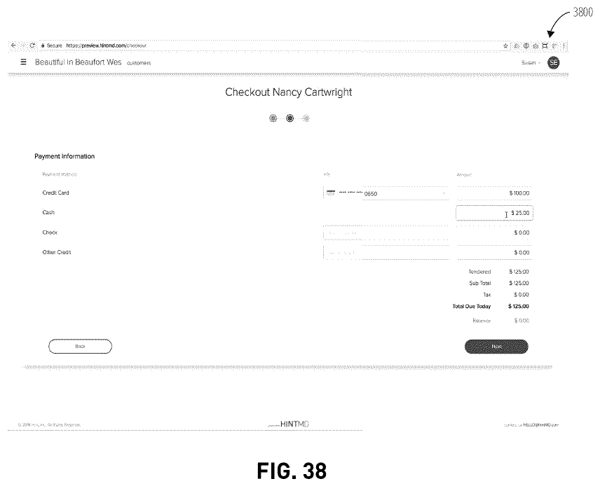

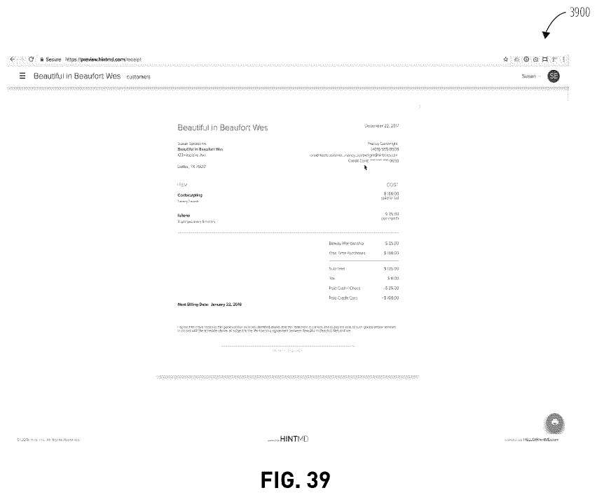

The payment information interface 3700 conveniently also allows a user to split the payment over multiple payment types, and accordingly input that only a portion of the payment total that is to be applied to a credit card, with the rest of the payment being paid in cash (or by check or other credit instruments). Once the payment information has been collected, the user selection of “next” button invokes the “payment received” interface 3800 (see FIG. 38). A “print for signature” button is user selectable to generate a printable version of a receipt (see FIG. 39), which again includes details on the plan, the payment made on the day, and how it was paid (i.e., which instruments were used to make the payments). The printable receipt also indicates a “next billing date” on which the next subscription payment will become payable. A signature line is also included.

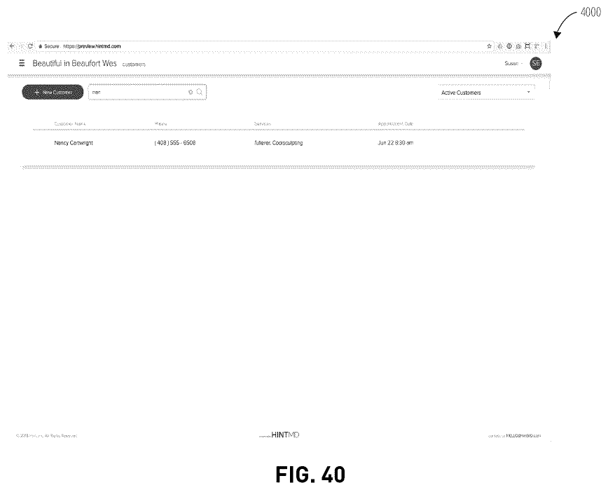

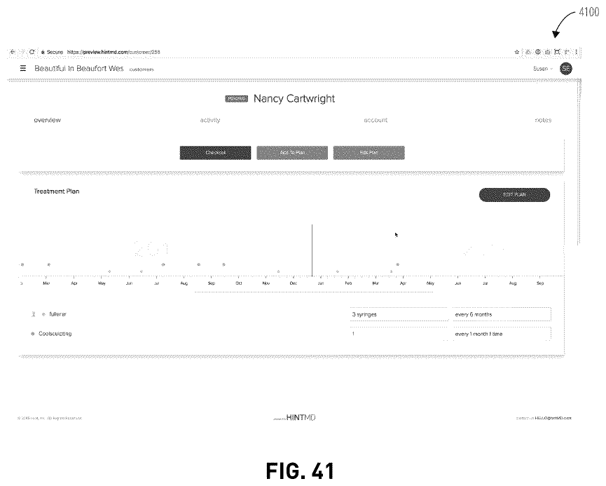

A user has the option of going back to the client list interface (see FIG. 40) and searching for the relevant customer to invoke a customer account overview interface 4100 (see FIG. 41). The customer account overview interface 4100 presents a timeline on which are indicated graphical representations of specific offering delivery events according to the plan. Offering-specific icons are displayed on a timeline adjacent or proximate dates on which the offerings are scheduled to be delivered, in accordance with the plan. The customer account overview interface 4100 thus provides a convenient graphical representation of the customer's plan. The plan can also be edited directly from the customer account overview interface 4100 for example, any of the quantity, recurrence period or duration of a particular offering can be modified from the overview interface. The recalculation of the monthly (or periodic) payment amounts will also automatically occur and be displayed within the overview interface responsive to any modifications made to the plan.

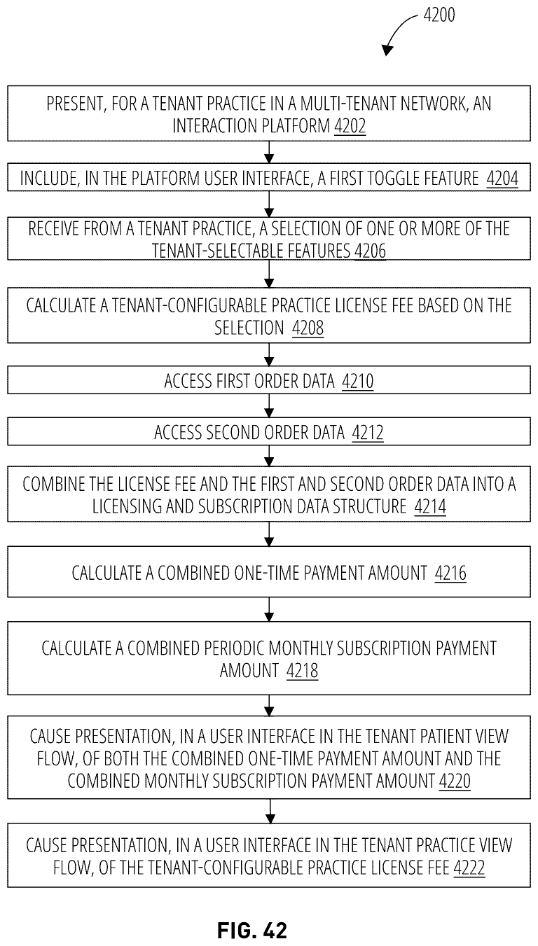

FIG. 42 is a flowchart illustrating a method 4200, according to some example embodiments, to generate user interfaces for a multi-tenant licensing and subscription management system, such as the licensing and subscription management system 132, or the licensing and subscription management system 320. Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

The method 4200 commences at operation 4202, in which method 4200 presents, for a tenant practice in a multi-tenant network, an interaction platform for receiving, via a platform user interface, health-related subscriptions from a tenant patient, the presented platform including a suite of invokable tenant-selectable features for processing data relating to the subscriptions and/or operations of the tenant practice. The presentation may accordingly be done via one or more interface in a tenant practice view flow that are generated and communicated from an appropriate expert system 124, via a web server 122, to a tenant device 110 being operated by a tenant 120.

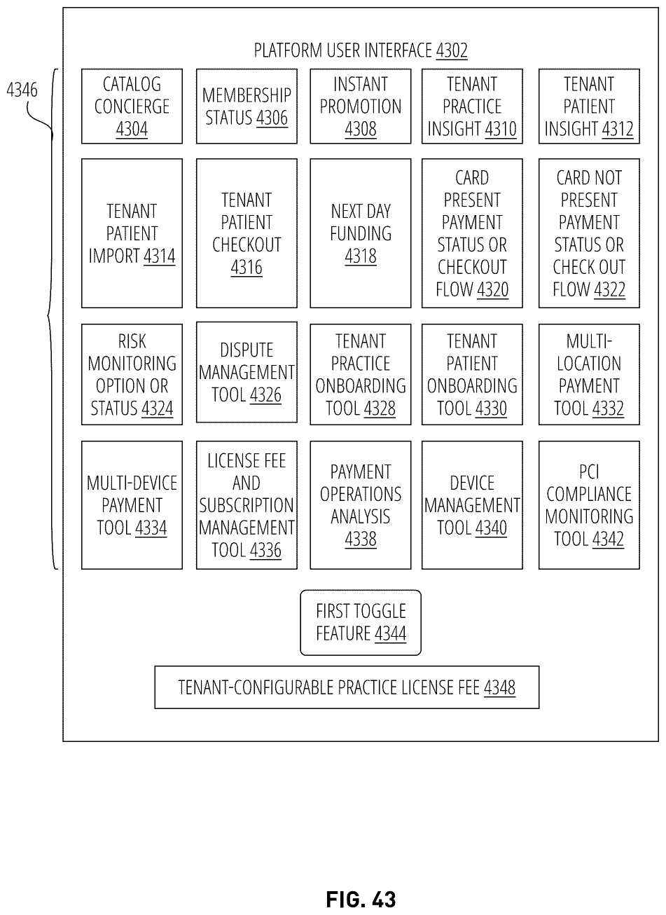

FIG. 43 illustrates an example platform user interface 4302 presenting a suite 4346 of invokable tenant-selectable features on which a tenant-configurable practice license fee can be based. The invokable tenant-selectable features include a catalog concierge 4304, a membership status 4306, an instant promotion 4308, a tenant practice insight 4310, a tenant patient insight 4312, a tenant patient import 4314, a tenant patient checkout 4316, a next day funding 4318, a card present payment status or checkout flow 4320, a card not present payment status or check out flow 4322, a risk monitoring option or status 4324, a dispute management tool 4326, a tenant practice onboarding tool 4328, a tenant patient onboarding tool 4330, a multi-location payment tool 4332, a multi-device payment tool 4334, a license fee and subscription management tool 4336, a payment operations analysis 4338, a device management tool 4340, and a compliance tool such as a PCI compliance monitoring tool 4342. Other invokable tenant-selectable features are possible. An invokable tenant-selectable feature has an associated license fee, or charge. A selection by a tenant 120 of one or more of the invokable tenant-selectable features forms the basis of a tenant-configurable practice license fee, as discussed further below.

The tenant-configurable practice license fee may be considered in some examples as a “consideration” for the provision of configurable enhanced technology to the licensing and subscription management system 132 or licensing and subscription management system 320 operated by a tenant 120. A tenant 120 can select one of more the invokable tenant-selectable features to add technology and functionality associated with the selected invokable tenant-selectable features to their licensing and subscription management system (for example the licensing and subscription management system 132 or the licensing and subscription management system 320) and pay a tailored or configured license fee, accordingly. Unnecessary functionality for a given tenant 120 is not charged for or provided. Yet, as a tenant practice grows or becomes more sophisticated, for example, enhanced technology available through a fresh selection of the invokable tenant-selectable features is always on hand and can be configured by a tenant 120 accordingly.

A selection of a given invokable tenant-selectable features allows access to a respective application or tool that can be invoked by a tenant 120 to process data, or gain further insights into their practice, for example. The applications or tools may be run on one or more of the application servers 104 of FIG. 1 for example.

In some examples, incorporation of catalog management technology (for example to manage offerings, goods, and services and so forth) is possible by selecting catalog concierge 4304. A catalog management application becomes available to the tenant 120 to assist in configuring an online offering of goods and services and related charges, for example.

In some examples, a membership application can be incorporated by selecting a membership status 4306 from the suite 4346 of invokable tenant-selectable features.

In some examples, for instance as part of a marketing campaign, one or more selected goods or services in a configured catalog can be made the subject of an instant promotion by selecting the instant promotion 4308 from the suite 4346 of invokable tenant-selectable features.

In some examples, data analysis applications can be incorporated by selecting the tenant practice insight 4310 and/or the tenant patient insight 4312 from the suite 4346 of invokable tenant-selectable features.

Patient management applications can be incorporated in some examples by selecting the tenant patient import 4314 feature, and/or the tenant patient checkout 4316 feature, and/or the multi-location payment tool 4332 feature, and/or the tenant practice onboarding tool 4328, and/or the tenant patient onboarding tool 4330, from the suite 4346 of invokable tenant-selectable features.

Transactions of goods and services can be facilitated or analyzed in some examples by selecting respective applications associated with the next day funding 4318 feature, and/or the card present payment status or checkout flow 4320 feature, and/or the card not present payment status or check out flow 4322 feature, and/or the multi-device payment tool 4334, and/or the license fee and subscription management tool 4336, and/or the payment operations analysis 4338 feature, and/or the device management tool 4340 from the suite 4346 of invokable tenant-selectable features.

In some examples, aspects relating to risk management can be facilitated or analyzed by selecting respective applications associated with the risk monitoring option or status 4324 feature, and/or the dispute management tool 4326 feature, and/or the PCI compliance monitoring tool 4342.

In operation 4204, method 4200 includes, in the platform user interface (for example platform user interface 4302 of FIG. 43), a first toggle feature 4344 feature selectable by the tenant practice to toggle between a tenant practice view flow (for example including the platform user interface 4302 of FIG. 43) and a tenant patient view flow (for example including the interfaces of FIG. 13 through FIG. 21 and/or through FIG. 22 through FIG. 41).

In operation 4206, method 4200 via an interface in the tenant practice view flow (for example platform user interface 4302), receives from a tenant practice (for example tenant 120), a selection of one or more of the tenant-selectable features. In operation 4208, method 4200 calculates a tenant-configurable practice license fee based on the selection of one or more of the tenant-selectable features.

In operation 4210, method 4200 accesses first order data relating to a first subscription offering to the tenant patient, the first order data including a first set of attributes relating to the first subscription offering. In operation 4212, method 4200 accesses second order data related to a second subscription offering to the tenant patient, the second order data including a second set of attributes related to the second subscription offering. In operation 4214, method 4200 combines the license fee and the first and second order data into a licensing and subscription data structure that includes quantity data and period data for each of the first and second subscription offerings. In operation 4216, method 4200 calculates a combined one-time payment amount for both the first and second subscription offerings based on the quantity data. In operation 4218, method 4200 calculates a combined periodic monthly subscription payment amount for both the first and the second subscription offerings based on the quantity and period data. In operation 4220, method 4200 causes presentation, in a user interface in the tenant patient view flow (for example including the interfaces of FIG. 13 through FIG. 21 and/or through FIG. 22 through FIG. 41), of both the combined one-time payment amount and the combined monthly subscription payment amount.

In operation 4222, method 4200 causes presentation, in a user interface in the tenant practice view flow (for example platform user interface 4302), of the tenant-configurable practice license fee (for example tenant-configurable practice license fee 4348 in FIG. 43). In this way, a tenant 120 can conveniently present or view both the tenant practice view flow and the tenant patient view flow by selecting the first toggle feature 4344. Each of these flows causes the respective tenant licensing and patient subscription information to be presented and updated. A tenant 120 (or user 118 such as a patient or expert) can thus conveniently review and configure licensing and subscription payment options at a checkout without having to perform any modification to the content of the cart.

The method may also include where the presentation includes presentation of a first user interface element to present the combined one-time payment amount and a second user element to present the combined monthly subscription payment amount, and presentation of a second toggle feature to toggle between the presentations of the first and second user interface elements. The second toggle element may include one or more features of the toggle element described further above with reference to FIG. 29. In this way, a user (e.g., a patient or expert) can conveniently present or view both the subscription option by selecting the subscription tab of the toggle element and the one-time payment option by selecting the one-time payment tab of the toggle element. Each of these tabs causes the presentation of the payment information to be updated and displayed in accordance with the selected payment option. A user (e.g., a patient or an expert) can thus conveniently review payment options at a checkout without having to perform any modification to the content of the cart.

The method may also include receiving third order data relating to a third offering, the third offering having a one-time payment option only, where the presentation includes a presentation of a one-time payment amount related to the third offering in conjunction with each of the combined one-time payment amount and the combined monthly subscription payment amount.

The method may also include where each of the first and second set of attributes includes an item identifier associated with at least one of an item or a service included in the offering.

The method may also include where each of the first and second set of attributes includes a recurring attribute identifying the respective offering as being recurring offering, and where the combining of the first and second order data is performed based on each of the first and second subscription offerings being identified as recurring offerings.

The method may also include communicating the combined monthly subscription payment amount from the licensing and licensing and subscription management system to a financial exchange system, the financial exchange system operating to present financing options relating to the combined monthly subscription payment amount to financiers.

The method may also include where the communication of the combined monthly subscription payment amount includes communicating further information pertaining to each of the first and second subscription offerings, the further information including identification information for a provider of the subscription offering, and identification information for a consumer of the subscription offering.

The method may also include receiving, at the financial exchange system, a financing offer related to at least one of the first or the second subscription offerings, the financing offer including financing terms, and further including communicating the financing offer from the financial exchange system to the licensing and licensing and subscription management system for presentation to a consumer.

The method may also include where the financing offer includes both a first financing offer pertaining to the first subscription offering and a second financing offer pertaining to the second subscription offering.

The method may also include where the licensing and licensing and subscription management system automatically applies predefined business rules to the first and second financing offers in order to selectively present at least one of the first or second financing offers to the consumer.

The method may also include where the suite of invokable tenant-selectable features includes one or more of a catalog concierge, a membership status, an instant promotion, a tenant practice insight, a tenant patient insight, a tenant patient import, a tenant patient checkout, a next day funding, a card present payment status or checkout flow, a card not present payment status or check out flow, a risk monitoring option or status, a dispute management tool, a tenant practice onboarding tool, a tenant patient onboarding tool, a multi-location payment tool, a multi-device payment tool, a license fee and subscription management tool, a payment operations analysis, a device management tool, and a PCI compliance monitoring tool. Other technical features may be readily apparent to one skilled in the art from the following figures, descriptions, and claims.

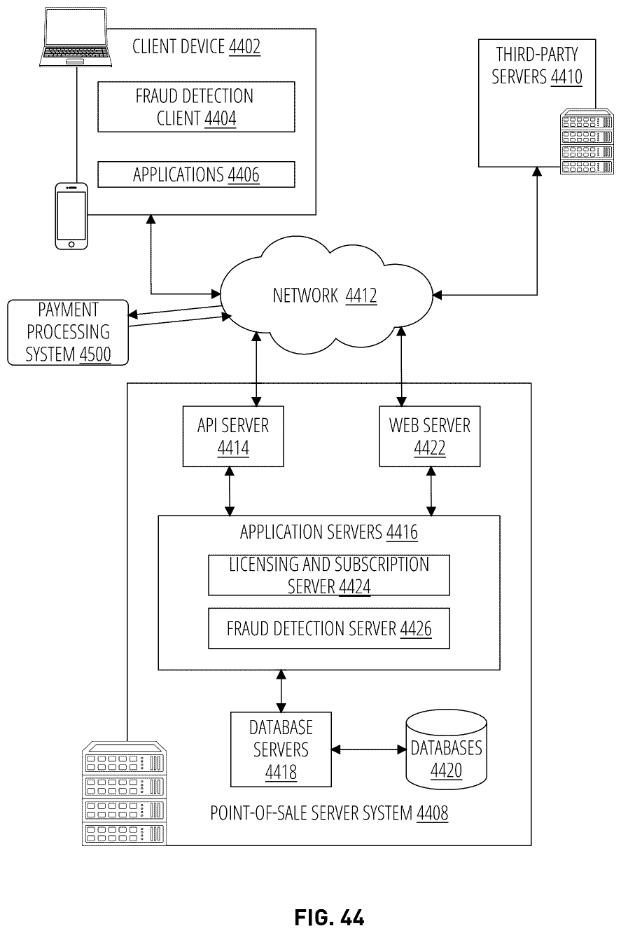

FIG. 44 is a block diagram showing an example point-of-sale system for conducting transactions over a network. The point-of-sale system is communicatively coupled to the payment processing system 4500 as part of the processing of card present payment transactions as described more fully below. The point-of-sale system includes multiple instances of a client device 4402, each of which hosts a number of applications, including a fraud detection client 4404 and other applications 4406. Each fraud detection client 4404 is communicatively coupled to other instances of the fraud detection client 4404 (e.g., hosted on respective other client devices 4402), a point-of-sale server system 4408, and third-party servers 4410 via a network 4412 (e.g., the Internet). The applications 4406 can also communicate with other locally-hosted applications 4406 using Applications Program Interfaces (APIs).

The point-of-sale server system 4408 provides server-side functionality via the network 4412 to a fraud detection client 4404. While certain functions of the point-of-sale system are described herein as being performed by either a fraud detection client 4404 or by the point-of-sale server system 4408, the location of certain functionality either within the fraud detection client 4404 or the point-of-sale server system 4408 may be a design choice. For example, it may be technically preferable to initially deploy certain technology and functionality within the point-of-sale server system 4408 but to later migrate this technology and functionality to the fraud detection client 4404 where a client device 4402 has sufficient processing capacity.

The point-of-sale server system 4408 supports various services and operations that are provided to the fraud detection client 4404. Such operations include transmitting data to, receiving data from, and processing data generated by the fraud detection client 4404. This data may include transaction data, customer data, product data, subscription data and provider data, as examples. Data exchanges within the point-of-sale server system 4408 are invoked and controlled through functions available via user interfaces (UIs) of the fraud detection client 4404.

Turning now specifically to the point-of-sale server system 4408, an API server 4414 is coupled to, and provides a programmatic interface to, application servers 4416. The application servers 4416 are communicatively coupled to a database server 4418, which facilitates access to a database 4420 that stores data associated with the transactions processed by the application servers 4416. Similarly, a web server 4422 is coupled to the application servers 4416 and provides web-based interfaces to the application server 4416. To this end, the web server 4422 processes incoming network requests over the Hypertext Transfer Protocol (HTTP) and several other related protocols.

The API server 4414 receives and transmits transaction data (e.g., commands and transaction data) between the client device 4402 and the application servers 4416. Specifically, the API server 4414 provides a set of interfaces (e.g., routines and protocols) that can be called or queried by the fraud detection client 4404 in order to invoke functionality of the application servers 4416. The API server 4414 exposes various functions supported by the application servers 4416, including account registration, subscription creations and management, the processing of transactions, via the application servers 4416, from a particular fraud detection client 4404 to another fraud detection client 4404.

The application servers 4416 host a number of server applications and subsystems, including, for example, a licensing and subscription server 4424 and a fraud detection server 4426. The licensing and subscription server 4424 implements functionalities for creating and managing subscriptions between multiple client devices 4402.

The fraud detection server 4426 provides functionalities for pre-declining fraudulent card transactions based on an evaluation of the transaction. Further details regarding the fraud detection server 4426 are provided below.

With reference to FIG. 45, in some examples, the point-of-sale server system 4408 is included in a payment processing system 4500 or conglomerate of payment systems. The payment processing system 4500 may include payment deduplicating and fraud-detecting functionality. The payment processing system 4500 processes payment or transaction data.

In relation to fraud detection operations, the payment processing system 4500 may operate as or include a microservices depot including connections to one or more microservices databases, for example, including the illustrated microservice databases 4502, 4504, 4506, and 4508. The payment processing system 4500 and microservice databases may operate in a multi-tenant network 4510 including at least one tenant 120, as an example tenant (e.g., tenant 120 of FIG. 1) in the multi-tenant network 4510. The tenant 120 may serve a consumer or patient (for example the user 118 of FIG. 1) and seek to receive a payment from this party for a subscription, item, or service, for example.

In some examples, the payment processing system 4500 includes a number of microsystems that each provide an associated microservice for a given tenant in the multitenant environment. Example microservices may include a point-to-point (P2P) encryption microservice (that writes to the microservice database 4502, for example), a global gateway microservice (that writes to the microservice database 4504, for example), a card microservice (that writes to the microservice database 4506, for example), and a payment microservice (that writes to the microservice database 4508, for example). Other microservices are possible.

In an example transaction, a patient at the tenant 120 swipes a card to pay for a product or service. Many other different types of transactions 4512 (such as sales (purchase), refunds, credits, loyalty program redemptions and so forth) may be received from any one or more of the patients at any one of more of the tenants in the multi-tenant network 4510. The numbers of patients and tenants can run into the thousands or even millions. It will be appreciated that the number, variety, and complexity of the transactions 4512 can be very high. In some examples, the payment processing system 4500 is configured to process this great multiplicity of transactions to check for fraud in near real-time.

When the example transaction is received at the tenant 120, at least one of the microservices in the payment processing system 4500 is invoked based on the nature or type of the transaction and writes out to its associated microservice database. As the transactions 4512 each proceed, each microservice database 4502-4508 collects its own related part of the transaction information; for example, the microservice database 4508 collects information for payment transactions (e.g., cash transactions), while the microservice database 4506 collects information for credit or debit card transactions. Other microservices are possible.

In some examples, the microservices depot includes a further microservice (not shown) called a ledger microservice. An associated ledger microservice database stores aspects related to transactional bookkeeping, recording aspects such as a transaction ID, a transaction dollar amount, details of an item, product or service purchased, and so forth. The ledger microservice operates as a ledger and keeps a tally of such details. The ledger information may be distributed or shared with all the other microservices.

In some examples, the data stored in microservice database 4502-4508 is transmitted (or otherwise made available) at operation 4514 to an “extract, load and transform” (ELT) tool, such as the illustrated ELT tool 4516. An example ELT tool 4516 may be (or include) a Matillion™ ELT tool 4516. For all of the microservices (including the ledger microservice), the ELT tool 4516 can perform ELT operations based on the continuous data supplied to it from the microservices databases 4502, 4504, 4506, and 4508, including, in some examples, the ledger microservice database.

In some examples, an output 4518 of the ELT tool 4516 includes normalized data or online transaction processing (OLTP) data that has been extracted, loaded, and transformed into star schemas and stored in a database, such as the Redshift database 4520. In some examples, the ELT tool 4516 extracts OLTP data, data from external online transaction processing databases, and data from any one or all of the microservice databases; loads the data; transforms this data into an abstracted, online analytical processing structure; and stores this as one or more star schemas in the Redshift database 4520.

In some examples, in parallel with the ELT process, the ELT tool 4516 also aggregates transactional information as part of its transformation, and then pushes at operation 4522 this aggregated data for storage in a Dynamo database 4524. In one sense, this operation may be considered to be moving information from what is a reporting infrastructure into a transaction processing resource. At operation 4526, the payment processing system 4500 and each of the microservices have access to this Dynamo database 4524 for fraud detection purposes and evaluation against near real-time aggregated information and ongoing real-time transactions 4512.

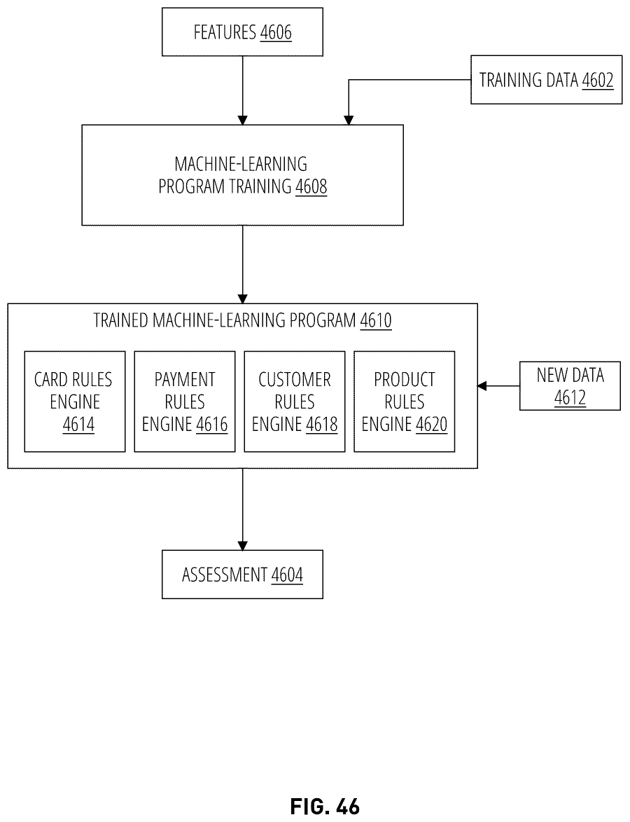

This aggregation of transactional data allows for the creation of fraud detection rules or threshold fraud parameters. Rules or threshold parameters may be based, for example, on an average monthly volume per practice for an individual practice (tenant) or patient. Other rules and thresholds are described further below in connection with machine learning with reference to FIG. 46.

As opposed merely to providing fixed fraud detection rules or threshold parameters, some examples allow for dynamic rule setting and flexibility in configuration. Assume a new practice joins a medical network as an example multitenant environment. Here, based on the type of practice it is and based on what has been seen historically across sets of practices, examples allow different machine learning algorithms to predict what an average sales price for use as a fraud detection trigger might be for the new practice. The new practice can be immediately protected and “inherit” existing rules and threshold parameters, accordingly.

Examples can also predict that a purchase, for example a neurotoxin like Botox, includes a certain average reorder time or purchase frequency. A purported reorder transaction for the same product that is received in too short a time, or at an increased frequency, is potentially fraudulent. Based on such purchase patterns, fraud scores for a given transaction can be developed and processed, accordingly. This is described in greater detail below with reference to FIG. 46.

In relation to payment deduplication functionality, some examples of a payment processing system 4500 herein generate an alert based on a detection that multiple payments are being issued for the same purchase of a subscription, item or service in order to prevent multiple payments being collected for the same purchase. Examples seek to provide a technical solution assisting users to prevent re-running multiple payments for the same purchase, either inadvertently or due to system glitches.

In this regard, the payment processing system 4500 includes at least one processor and a memory storing instructions that, when executed by the at least processor, cause the payment processing system 4500 to perform operations comprising detecting a card-present (CP) transaction request that comprises a set of CP transaction data, the CP transaction request relating to a purchase of an item or service and initiated by a card swipe or card tap made by human user (for example, user 118) at a Point-of-Sale tenant device 110 device operating at a tenant (for example a tenant 120) in a multi-tenant network (for example multi-tenant network 4510); accessing the CP transaction data; monitoring a flow of the CP transaction data across a plurality of communicatively-coupled CP transaction processing components, the CP transaction processing components including at least the tenant device 110, a federation layer 4530 executing between tenants 120 in the multi-tenant network 4510, a peer-to-peer encryption service 4532 accessible by the tenant device 110 and invoked by the CP transaction request, a gateway service 4534 acting as an exclusive contact point for the tenant device 110, and an application-support server (for example, application server 104) executing or processing data for a payment application to present at least some of the CP transaction data in a user interface of a mobile device (for example, client device 108) operated by the human user; detecting a failure or breakdown in the flow of monitored CP transaction data; detecting an attempted re-initiation of the CP transaction request for the same purchase of the item or service, the attempted re-initiation of the CP transaction request made after the detected failure or breakdown in the flow of monitored CP transaction data, the re-initiated CP transaction request including re-initiated CP transaction data; accessing the re-initiated CP transaction data; based on the detected re-initiation of the CP transaction request, comparing the CP transaction data against the re-initiated CP transaction data to identify an attempted duplicated payment for the purchase of the item or service; and based on the identified attempted duplicated payment, initiating a payment deduplication phase by generating a potential payment duplication alert for presentation at the tenant device 110 and/or in the user interface of the client device 108 operated by the human user.

In some examples, the operations further comprise, based on a response to the payment duplication alert, progressing the payment deduplication phase by voiding, or facilitating a voiding of, either one of the initial and re-initiated CP transaction requests. In some examples, progressing the payment deduplication phase further comprises processing a non-voided initial or re-initiated CP transaction request. In some examples, the response to the potential payment deduplication alert is received at the tenant device 110. In some examples, the response to the potential payment deduplication alert is received from the mobile device (client device 108) operated by the human user.

In some examples, comparing the CP transaction data against the re-initiated CP transaction data further comprises inputting the CP transaction data into a machine-learned model trained to analyze a set of historical transaction data, the set of historical transaction data having been aggregated from one or more historical data sources, the one or more historical data sources including at least one microservice database collecting a particular aspect of transactional data processed by a corresponding microservice of the tenant in the multi-tenant network; using an output of the machine-learned model to generate a transaction comparison fingerprint based on common or repeated tenant or human user payment transactions; storing the transaction comparison fingerprint in a transaction comparison fingerprint cache table, and monitoring a frequency or number of times the CP transaction data matches a transaction comparison fingerprint; comparing the CP transaction data against at least one transaction comparison fingerprint in the transaction comparison fingerprint cache table to generate a comparison result; and based on the comparison result, or the monitored frequency or number of matches, generating the potential payment duplication alert.

In some examples, monitoring the flow of the CP transaction data across the plurality of communicatively-coupled CP transaction process components includes monitoring for a failure or breakdown including at least one of a card decline, a network error, a request time out, a gateway time out, a failed response receipt, a bank error, a processor error, a lost connection, a power loss, a device reboot, and a device restart. In some examples, the tenant in the multi-tenant network is an aesthetic medical practice in a network of medical service providers, and wherein the human user is a patient at the aesthetic medical practice.

FIG. 46 illustrates the training and use of a machine-learning program, according to some embodiments that may be used in conjunction with the fraud detection and payment deduplication (e.g., fingerprint generation) operations discussed above in connection with FIG. 45. In some embodiments, machine-learning programs (MLPs), also referred to as machine-learning algorithms or tools, are utilized to perform operations associated with malware classification. Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 4602 in order to make data-driven predictions or decisions expressed as outputs or assessment 4604. Although some embodiments are presented with respect to a few machine-learning tools, the principles presented herein may be applied to other machine-learning tools.

In some embodiments, different machine learning tools may be used. For example, Logistic Regression (LR), Naive-Bayes, Random Forest (RF), neural networks (NN), matrix factorization, and Support Vector Machines (SVM) tools may be used for classifying or scoring transaction data.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a prediction probability to classify an image as digitally manipulated or not. The machine-learning algorithms utilize the training data 4602 to find correlations among identified features 4606 that affect the outcome.

The machine-learning algorithms utilize features 4606 for analyzing the data to generate an assessment 4604. The features 4606 are an individual measurable property of a phenomenon being observed. The concept of a feature is related to that of an explanatory variable used in statistical techniques such as linear regression. Choosing informative, discriminating, and independent features is important for effective operation of the MLP in pattern recognition, classification, and regression. Features may be of different types, such as numeric features, strings, and graphs. In one embodiment, the features 4606 may be of different types. For example, the features 4606 may be features of historical transaction data.

The machine-learning algorithms utilize the training data 4602 to find correlations among the identified features 4606 that affect the outcome or assessment 4604. In some embodiments, the training data 4602 includes labeled data, which is known data for one or more identified features 4606 and one or more outcomes, such as detecting fraudulent transactions.

With the training data 4602 and the identified features 4606, the machine learning tool is trained during machine-learning program training 4608. Specifically, during machine-learning program training 4608, the machine-learning tool appraises the value of the features 4606 as they correlate to the training data 4602. The result of the training is the trained machine-learning program 4610.

When the trained machine-learning program 4610 is used to perform an assessment, new data 4612 is provided as an input to the trained machine-learning program 4610, and the trained machine-learning program 4610 generates the assessment 4604 as output. For example, when transaction data is received, the historical transaction data is accessed, and the weights of the corresponding data sources are computed, the machine-learning program utilizes features of the historical transaction data to determine if the received transaction request is fraudulent or not.

In some examples, the trained machine-learning program 4610 includes a series of rules engines. Each rules engine includes a list of rules that the incoming transaction request is evaluated against before providing the assessment 4604. For example, the trained machine-learning program 4610 may include a card rules engine 4614, a payment rules engine 4616, a customer rules engine 4618, and a product rules engine 4620. The card rules engine 4614 includes a set of rules that the card data associated with transaction request must be evaluated against before providing the assessment 4604. The payment rules engine 4616 includes a set of rules that the payment data associated with the transaction request must be evaluated against before providing the assessment 4604. The customer rules engine 4618 includes a set of rules that the customer data associated with the transaction must be evaluated against before providing the assessment 4604. The product rules engine 4620 includes a set of rules that the product data must be evaluated against before providing the assessment 4604.

In some examples, payment transaction data or a fingerprint may be based on or include one or more of a merchant (tenant) ID, a patient (user) ID, or an amount of time, for example a payment transaction including these three value fields performed within a value X of a monitored time period or frequency, where X is a configurable value.

In some examples, training data for machine learning purposes is aggregated and encrypted (or anonymized) in a multitenant environment. Some fraud detection examples relate to or include data aggregation and anonymization in multi-tenant networks or networks and, in some examples, to a data aggregator and anonymizer that can encrypt sensitive data received from multiple tenants as data sources. The sensitive data may include Personally Identifiable Information (PII), Protected Health Information (PHI) and Payment Card Industry (PCI) information. In some examples, anonymized data can be aggregated for multi-faceted testing without disclosing sensitive aspects. In some examples, the aggregated data can be selectively unencrypted to a given tenant.

Results derived from an analysis of “big data” can generally be improved if the volume of test data is significant. Typically, the larger the volume of test data, the more accurate an analysis of it will be. For example, there is greater chance to identify data outliers and trends in a significant body of data. Data aggregation, however, is not easy. It may be aggregated from different sources, but each source will likely have different methods of data protection with which to comply. Each source will also very often have different data content and configuration, and this may conflict with data configuration of other sources. This aggregation of disparate sources of protected information presents technical challenges, particularly in multi-tenant networks or environments. The more data that is collected, the more complicated the security protocols become and the greater the risk of inadvertent disclosure or malicious access to it. Great care is required not to disclose encrypted information to third-party sources of aggregated data, or third-party “big data” analyzers scrutinizing collected data for discernible trends or machine-learning purposes, for example.

According to some example embodiments, techniques and systems are provided for data aggregation and anonymization in multi-tenant networks or environments. In some examples, a data aggregator and anonymizer platform can encrypt sensitive data received from multiple tenants as data sources. The sensitive data may include PII, PHI, and PCI information. In some examples, anonymized data can be aggregated for multi-faceted testing without disclosing sensitive aspects. In some examples, a portion of the aggregated data can be selectively unencrypted and returned or presented to a tenant that was the original source or keeper of that portion of the aggregated data. The remainder of the portions are not unencrypted and may continue to form part of a body of test data.

Fundamental problems that may arise when processing data in strict compliance to a regulated environment, involving PPI, PHI, or PCI for example, can occur at a confluence of healthcare and treatment information records. One challenge includes simulating a set of problems in production data using test data. For a single medical practice, for example, subscribing along with other medical practices (tenants) to a licensing and subscription service (for example) in a multi-tenant network, using a small set of test data based on its own production data may limit the body of test data that can be assembled. On the other hand, trying to build a bigger set of test data by incorporating data from other tenants accessible in the multi-tenant network runs a serious risk of privacy invasion and breach of compliance laws. Further, a desire to collect a large body of data for testing and analysis may include sourcing data that is external to the multi-tenant network and may involve the participation of third parties to analyze the data (e.g., “big data” analysis). Thus, data protection laws prevent a mere aggregation of production data for test purposes.

In other aspects, a further challenge is to simulate realistically, in test environments, what is really happening in production environments. It is difficult to obtain a representative sample of test data that actually and realistically reflects production conditions of whatever aspect the tenant may be developing (for example, an updated health service to patients, a new product offering, or an enhanced online functionality).

In further challenging aspects, production and test systems usually have layers. Lower layers can be accessed by many people, while higher layers can be accessed by relatively few. Access and security protocols differ across layers. In a regulated environment, one cannot easily bring down test information into lower layers because this may violate one or more compliance laws since wider access to this information is provided.

In order to address these and other challenges, some present examples, at a high level, classify and encrypt test information, in particular sensitive information contained in the test information, before it is brought down to lower layers. A representative sample of anonymized test data is made available for testing and, in some examples, is configurable based on data fields that might remain or are encrypted, among other factors. Once the encrypted information is brought down to lower layers, the anonymized test data may be used for a variety of testing purposes during development of a service or product, as discussed above.

Some present examples aggregate data to create a body of test data. The aggregated data may include data sourced from sources other than a single tenant (in other words, an aggregation of multi-tenant or multi-party data). For testing purposes, data analysis, or machine training purposes, an enhanced body of test data may be useful to a tenant or third-party data analyzer even though not all of the aggregated data may have been sourced from it. In this situation, a complicated cross-matrix of protection protocols such a PII, PHI, and PCI may apply, and each tenant may be entitled only to view the portion of the data that it supplied (or at least view an unencrypted version of that data). Present examples of a data aggregator and anonymizer platform facilitate the creation and access to such combined test data, yet still allow and greatly facilitate compliance with data protection laws in doing so.

In cloud-based and other modern systems (e.g., Software-as-a-Service (SaaS) platforms and so forth), most enterprises rely very heavily on third-party applications to process data. Some of these applications may include “big data” processing systems. The enterprise cannot physically control what these third parties do with their data. While inter-party agreements restricting data access and publication may be established, there is always a possibility of a rogue actor acting outside the agreed terms. A rogue actor at one tenant in a multi-tenant network might use network credentials to access another tenant to look up prohibited data. The accessed data might be used for exploitation or ransomware purposes, for example.

Thus, in some present examples, a data aggregator and anonymizer can aggregate and provide anonymized data that, even if accessed by a rogue actor, does not contain any identifying information. In some examples, a data encryption key is used to encrypt test data. In some examples, a decryption key to unlock test data is destroyed. In some examples, a decryption key to unlock a portion of aggregated test data is provided only to the tenant supplying that portion. The decryption key disallows decryption of any other data. The tenant as a source of data is thus placed in the same (unencrypted) position it was before supplying a portion of data to be aggregated, yet has enjoyed the benefit of results and analysis derived from a much larger body of test data sourced from many other, if not all, tenants in a multi-tenant network. The tenants are reassured that any contributed data that has been aggregated and shared with another tenant or third-party data analyzer has nevertheless remained encrypted for purposes such as testing, “big data” analysis, machine learning, and so forth.

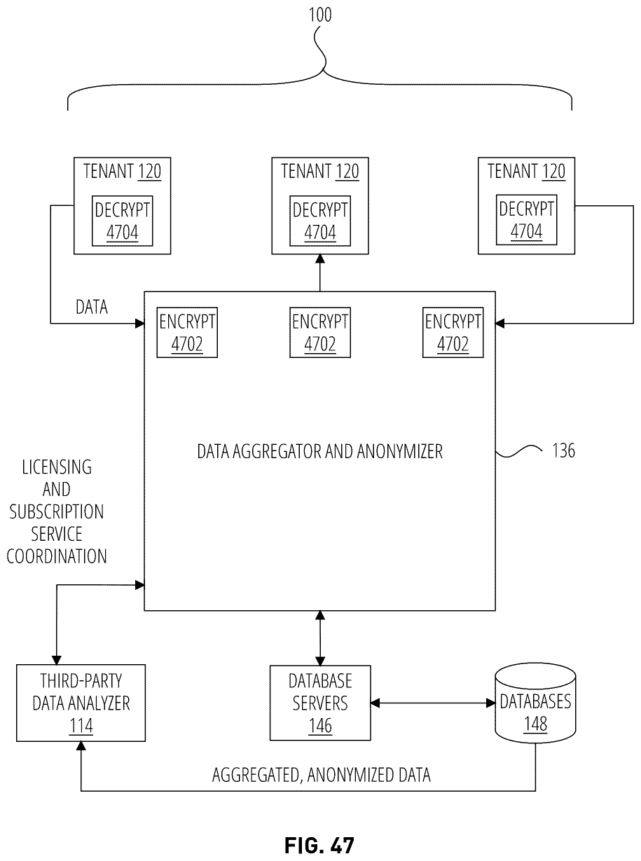

With reference to FIG. 47, in some examples, a tenant 120 in a multi-tenant network 100 may wish to create a testing environment in which to develop a new product or service. To that end, in present examples, the tenant 120 can contact the licensing and subscription service 106 and request an aggregation of test data or an analysis of a body of data to help in developing the product or service. The licensing and subscription service 106 invokes the data aggregator and anonymizer 136 shown in the view. The tenant 120 may contribute some data, such as production data, to be aggregated or anonymized for test purposes. Some of this production data may be covered by PII, PHI, or PCI requirements and will therefore require appropriate treatment before it can be analyzed by or shared with others. As described more fully below, the aggregated test data is classified to identify sensitive data and encrypted accordingly. The test data is aggregated by the data aggregator and anonymizer 136 to assist in simulating production conditions in which to test the tenant's proposed product or service. In some examples, a plurality of tenants 120 may request an analysis of their respective production data or a simulation of a real-life real-time production environment.

The data aggregated by the data aggregator and anonymizer 136 may be derived from a number of different data sources to assist in creating a realistic test environment or a rich body of data for analysis and training, for example. In some examples, the data may be sourced from a number of sources, without limitation. A data source may include, for example, a single tenant in a network, a plurality of tenants in a network, a single third party outside of a network, or a plurality of third parties outside of a network. Tenants or third parties may be sources of application data, web-based traffic data, or other types of data. Tenants and third parties may offer analysis tools and machine learning models, or other services.

Whether requested by a single tenant 120, or several tenants 120, the aggregated data may comprise a complicated cross-matrix of protection protocols such as PII, PHI, and PCI. Each tenant 120 may be entitled only to view a portion of the data that it supplied or, if permitted, an unencrypted version of that data.

In some examples, data sent by a tenant or accessed by the data aggregator and anonymizer 136 is encrypted at 4702 upon receipt or a grant of access. In some examples, when test data, or analyzed data results, are sent back to a tenant 120, this portion of the data is decrypted at 4704. These processes are described more fully below. The aggregated and anonymized data is stored in a database, such as the one or more databases 148 described above. Present examples of a data aggregator and anonymizer 136 facilitate the creation and access to combined test data, yet still allow and greatly facilitate compliance with data protection laws in so doing.

In some examples, one or more third-party data analyzers 114 may request access to the aggregated and anonymized data stored in the database 148 for purposes of analyzing it to support the tenant's product or service development mentioned above. A third-party data analyzer 114 may be contracted by the licensing and subscription service 106, or a tenant 120, to perform data analysis. With appropriate authorization, the third-party data analyzer 114 may be granted access to the data stored in the database 148. To the extent any access is granted, or to the extent a rogue actor may be at work, the aggregated data stored in the database 148 remains anonymized and yields no sensitive information. The data stored in the database 148 may be safely used by the third-party data analyzer 114, or a tenant 120, or the data aggregator and anonymizer 136, in a number of ways including, for example, data analysis, the development of models for machine learning, and for other purposes.

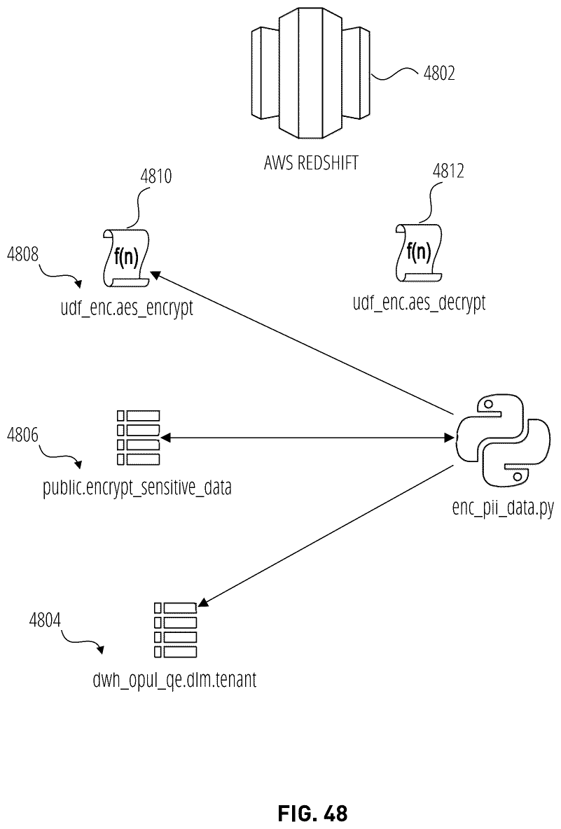

With reference to FIG. 48, some examples, particularly those that utilize the cloud or cloud-based services, include layers, such as software, application, or storage layers, responsible for or utilized in certain aspects of data usage and processing from an origin to post-production. One aspect includes encryption. An example encryption can include an Advanced Encryption Standard (AES). AES follows a symmetric encryption algorithm, i.e., the same key is used to encrypt and decrypt the data. AES supports block lengths of 528, 592, and 556 bits. One example, in a data analytics or reporting tier, includes Amazon Web Services (AWS) Redshift 4802 for encryption and decryption. Redshift is used in some examples to encrypt and decrypt data in various layers. Other encryption software is possible.

In some examples, an AES encryption level is specific to a database persistence layer, for example as shown in FIG. 48. At a first layer 4804, stored data is sourced from one or more tenants 120 and aggregated. At layer 4806, sensitive data in the aggregated data is identified and encrypted. These operations may occur at the data aggregator and anonymizer 136 using database 148 (FIG. 1), for example. Sensitive data is scrambled, hashed, or randomly keyed in some examples. At layer 4808 (for example a lower, widely distributed layer), data is encrypted at 4810 so that it is rendered anonymous. Users operating in this lower level layer 4808 have no access to sensitive data, or if access is obtained, the data is meaningless because it has been anonymized. The data can be decrypted at 4812 as needed for authorized provision to a tenant seeking full access to their data. These encrypt/decrypt operations may occur at the data aggregator and anonymizer 136 or at a tenant 120 (FIG. 1), in some examples. The aggregated, anonymized data may be stored in database 148 (FIG. 1).

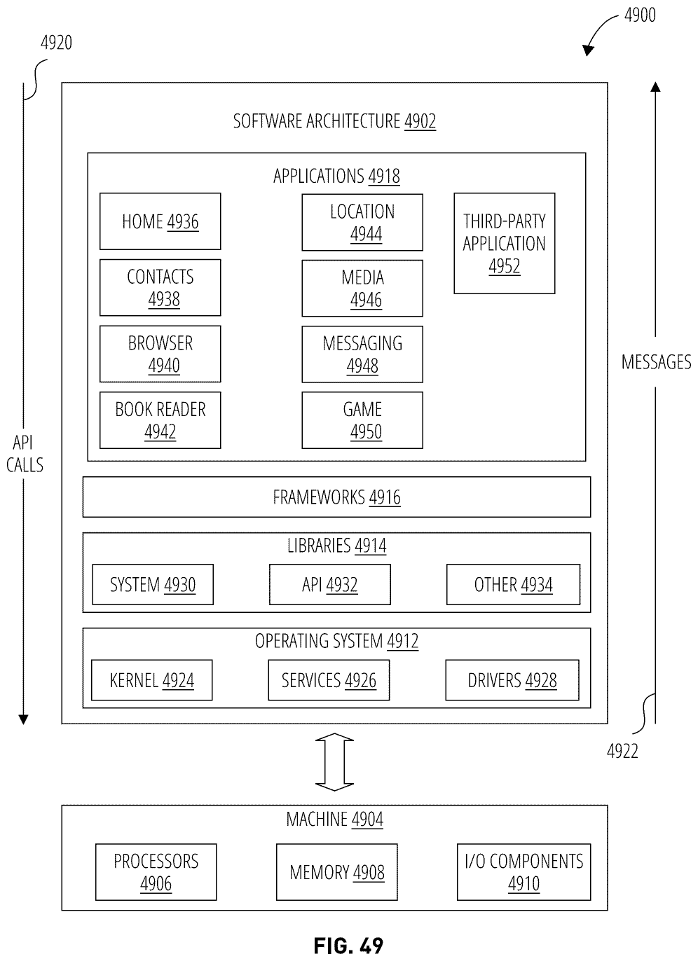

FIG. 49 is a block diagram 4900 illustrating a software architecture 4902, which can be installed on any one or more of the devices herein. FIG. 49 is merely a non-limiting example of a software architecture, and it will be appreciated that many other architectures can be implemented to facilitate the functionality described herein. In various embodiments, the software architecture 4902 is implemented by hardware such as a machine 4904 of FIG. 49 that includes processors 4906, memory 4908, and I/O component 4910. In this example architecture, the software can be conceptualized as a stack of layers where each layer may provide particular functionality. For example, the software includes layers such as an operating system 4912, libraries 4914, frameworks 4916, and applications 4918. Operationally, the applications 4918 invoke application programming interface (API) calls (API calls) 4920 through the software stack and receive messages 4922 in response to the API calls 4920, consistent with some embodiments.

In various implementations, the operating system 4912 manages hardware resources and provides common services. The operating system 4912 includes, for example, a kernel 4924, services 4926, and drivers 4928. The kernel 4924 acts as an abstraction layer between the hardware and the other software layers, consistent with some embodiments. For example, the kernel 4924 provides memory management, processor management (e.g., scheduling), component management, networking, and security settings, among other functionality. The services 4926 can provide other common services for the other software layers. The drivers 4928 are responsible for controlling or interfacing with the underlying hardware, according to some embodiments. For instance, the drivers 4928 can include display drivers, camera drivers, BLUETOOTH® or BLUETOOTH® Low Energy drivers, flash memory drivers, serial communication drivers (e.g., Universal Serial Bus (USB) drivers), WI-FIR drivers, audio drivers, power management drivers, and so forth.

In some embodiments, the libraries 4914 provide a common low-level infrastructure utilized by the applications 4918. The libraries 4914 can include system libraries 4930 (e.g., C standard library) that can provide functions such as memory allocation functions, string manipulation functions, mathematic functions, and the like. In addition, the libraries 4914 can include API libraries 4932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 4914 can also include a wide variety of other libraries 4934 to provide many other APIs to the applications 4918.

The frameworks 4916 provide a common high-level infrastructure that can be utilized by the applications 4918, according to some embodiments. For example, the frameworks 4916 provide various graphical user interface (GUI) functions, high-level resource management, high-level location services, and so forth. The frameworks 4916 can provide a broad spectrum of other APIs that can be utilized by the applications 4918, some of which may be specific to a particular operating system or platform.

In an example embodiment, the applications 4918 include a home application 4936, a contacts application 4938, a browser application 4940, a book reader application 4942, a location application 4944, a media application 4946, a messaging application 4948, a game application 4950, and a broad assortment of other applications such as a third-party application 4952. According to some embodiments, the applications 4918 are programs that execute functions defined in the programs. Various programming languages can be employed to create one or more of the applications 4918, structured in a variety of manners, such as object-oriented programming languages (e.g., Objective-C, Java, or C++) or procedural programming languages (e.g., C or assembly language). In a specific example, the third-party application 4952 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 4952 can invoke the API calls 4920 provided by the operating system 4912 to facilitate functionality described herein.

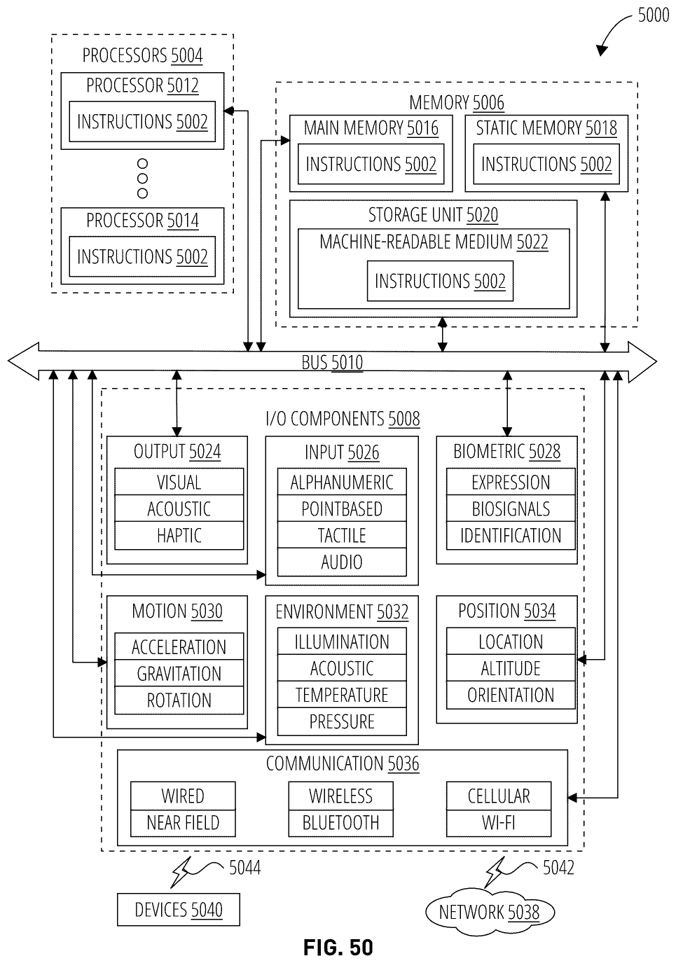

FIG. 50 illustrates a diagrammatic representation of a machine 5000 in the form of a computer system within which a set of instructions may be executed for causing the machine to perform any one or more of the methodologies discussed herein, according to example embodiments. Specifically, FIG. 50 shows a diagrammatic representation of the machine 5000 in the example form of a computer system, within which instructions 5002 (e.g., software, a program, an application, an applet, an app, or other executable code) for causing the machine 5000 to perform any one or more of the methodologies discussed herein may be executed. The instructions 5002 transform the general, non-programmed machine 5000 into a particular machine 5000 programmed to carry out the described and illustrated functions in the manner described. In alternative embodiments, the machine 5000 operates as a standalone device or may be coupled (e.g., networked) to other machines. In a networked deployment, the machine 5000 may operate in the capacity of a server machine or a client machine in a server-client network environment, or as a peer machine in a peer-to-peer (or distributed) network environment. The machine 5000 may comprise, but not be limited to, a server computer, a client computer, a personal computer (PC), a tablet computer, a laptop computer, a netbook, a set-top box (STB), a PDA, an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 5002, sequentially or otherwise, that specify actions to be taken by the machine 5000. Further, while only a single machine 5000 is illustrated, the term “machine” shall also be taken to include a collection of machines 5000 that individually or jointly execute the instructions 5002 to perform any one or more of the methodologies discussed herein.

The 5000 may include processors 5004, memory 5006, and I/O components 5008, which may be configured to communicate with each other such as via a bus 5010. In an example embodiment, the processors 5004 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 5012 and a processor 5014 that may execute the instructions 5002. The term “processor” is intended to include multi-core processors that may comprise two or more independent processors (sometimes referred to as “cores”) that may execute instructions contemporaneously. Although FIG. 50 shows multiple processors 5004, the machine 5000 may include a single processor with a single core, a single processor with multiple cores (e.g., a multi-core processor), multiple processors with a single core, multiple processors with multiples cores, or any combination thereof.

The memory 5006 may include a main memory 5016, a static memory 5018, and a storage unit 5020, both accessible to the processors 5004 such as via the bus 5010. The main memory 5016, the static memory 5018, and storage unit 5020 store the instructions 5002 embodying any one or more of the methodologies or functions described herein. The instructions 5002 may also reside, completely or partially, within the main memory 5016, within the static memory 5018, within machine-readable medium 5022 within the storage unit 5020, within at least one of the processors 5004 (e.g., within the processor's cache memory), or any suitable combination thereof, during execution thereof by the machine 5000.

The I/O components 5008 may include a wide variety of components to receive input, provide output, produce output, transmit information, exchange information, capture measurements, and so on. The specific I/O components 5008 that are included in a particular machine will depend on the type of machine. For example, portable machines such as mobile phones will likely include a touch input device or other such input mechanisms, while a headless server machine will likely not include such a touch input device. It will be appreciated that the I/O components 5008 may include many other components that are not shown in FIG. 50. The I/O components 5008 are grouped according to functionality merely for simplifying the following discussion, and the grouping is in no way limiting. In various example embodiments, the I/O components 5008 may include output components 5024 and input components 5026. The output components 5024 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 5026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 5008 may include biometric components 5028, motion components 5030 environmental components 5032, or position components 5034, among a wide array of other components. For example, the biometric components 5028 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 5030 may include acceleration sensor components (e.g., accelerometer), gravitation sensor components, rotation sensor components (e.g., gyroscope), and so forth. The environmental components 5032 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 5034 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 5008 may include communication components 5036 operable to couple the machine 5000 to a network 5038 or devices 5040 via a coupling 5042 and a coupling 5044 respectively. For example, the communication components 5036 may include a network interface component or another suitable device to interface with the network 5038. In further examples, the communication components 5036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 5040 may be another machine or any of a wide variety of peripheral devices (e.g., a peripheral device coupled via a USB).

Moreover, the communication components 5036 may detect identifiers or include components operable to detect identifiers. For example, the communication components 5036 may include Radio Frequency Identification (RFID) tag reader components, NFC smart tag detection components, optical reader components (e.g., an optical sensor to detect one-dimensional barcodes such as Universal Product Code (UPC) barcode, multi-dimensional bar codes such as Quick Response (QR) code, Aztec code, Data Matrix, Dataglyph, MaxiCode, PDF417, Ultra Code, UCC RSS-2D barcode, and other optical codes), or acoustic detection components (e.g., microphones to identify tagged audio signals). In addition, a variety of information may be derived via the communication components 5036, such as location via Internet Protocol (IP) geolocation, location via Wi-Fi® signal triangulation, location via detecting an NFC beacon signal that may indicate a particular location, and so forth.

The various memories (i.e., memory 5006, main memory 5016, static memory 5018, and/or memory of the processors 5004) and/or storage unit 5020 may store one or more sets of instructions and data structures (e.g., software) embodying or utilized by any one or more of the methodologies or functions described herein. These instructions (e.g., the instructions 5002), when executed by processor 5004, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 4320 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 5038 or a portion of the network 5038 may include a wireless or cellular network, and the coupling 5042 may be a Code Division Multiple Access (CDMA) connection, a Global System for Mobile communications (GSM) connection, or another type of cellular or wireless coupling. In this example, the coupling 5042 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 5002 may be transmitted or received over the network 5038 using a transmission medium via a network interface device (e.g., a network interface component included in the communication components 5036) and utilizing any one of a number of well-known transfer protocols (e.g., hypertext transfer protocol (HTTP)). Similarly, the instructions 5002 may be transmitted or received using a transmission medium via the coupling 5044 (e.g., a peer-to-peer coupling) to the devices 5040. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 5002 for execution by the machine 5000, and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A multi-tenant licensing and subscription management system comprising:
a processor; and
a memory storing instructions that, when executed by the processor, configure the licensing and subscription management system to perform operations including:
presenting, for a tenant practice in a multi-tenant network, an interaction platform for receiving, via a platform user interface, health-related subscriptions from a tenant patient, the presented platform including a suite of invokable tenant-selectable features for processing data relating to the subscriptions and/or operations of the tenant practice;
including, in the platform user interface, a first toggle feature selectable by the tenant practice to toggle between a tenant practice view flow and a tenant patient view flow;
via an interface in the tenant practice view flow, receiving from a tenant practice, a selection of one or more of the tenant-selectable features;
calculating a tenant-configurable practice license fee based on the selection of one or more of the tenant-selectable features;
accessing first order data relating to a first subscription offering to the tenant patient, the first order data including a first set of attributes relating to the first subscription offering;
accessing second order data related to a second subscription offering to the tenant patient, the second order data including a second set of attributes related to the second subscription offering;
combining the license fee and the first and second order data into a licensing and subscription data structure that includes quantity data and period data for each of the first and second subscription offerings;
calculating a combined one-time payment amount for both the first and second subscription offerings based on the quantity data;
calculating a combined periodic monthly subscription payment amount for both the first and the second subscription offerings based on the quantity and period data;
causing presentation, in a user interface in the tenant patient view flow, of both the combined one-time payment amount and the combined monthly subscription payment amount; and
causing presentation, in a user interface in the tenant practice view flow, of the tenant-configurable practice license fee.

2. The licensing and subscription management system of claim 1, wherein the presentation in the tenant patient view comprises presentation of a first user interface element to present the combined one-time payment amount and a second user element to present the combined monthly subscription payment amount, and presentation of a second toggle feature to toggle between the presentations of the first and second user interface elements.

3. The licensing and subscription management system of claim 1, wherein the operations further comprise receiving third order data relating to a third offering, the third offering having a one-time payment option only, wherein the presentation includes a presentation of a one-time payment amount related to the third offering in conjunction with each of the combined one-time payment amount and the combined monthly subscription payment amount.

4. The licensing and subscription management system of claim 1, wherein each of the first and second set of attributes comprises an item identifier associated with at least one of an item or a service included in the offering.

5. The licensing and subscription management system of claim 1, wherein each of the first and second set of attributes comprises a recurring attribute identifying the respective offering as being recur offering, and wherein the combining of the first and second order data is performed based on each of the first and second subscription offerings being identified as recurring offerings.

6. The licensing and subscription management system of claim 1, wherein the operations further comprise communicating the combined monthly subscription payment amount from the licensing and licensing and subscription management system to a financial exchange system, the financial exchange system operating to present financing options relating to the combined monthly subscription payment amount to financiers.

7. The licensing and subscription management system of claim 6, wherein the communication of the combined monthly subscription payment amount includes communicating further information pertaining to each of the first and second subscription offerings, the further information including identification information for a provider of the subscription offering, and identification information for a consumer of the subscription offering.

8. The licensing and subscription management system of claim 6, wherein the operations further comprise receiving, at the financial exchange system, a financing offer related to at least one of the first or the second subscription offerings, the financing offer including financing terms, and further include communicating the financing offer from the financial exchange system to the licensing and licensing and subscription management system for presentation to a consumer.

9. The licensing and subscription management system of claim 8, wherein the financing offer includes both a first financing offer pertaining to the first subscription offering and a second financing offer pertaining to the second subscription offering.

10. The licensing and subscription management system of claim 9, wherein the licensing and licensing and subscription management system automatically applies predefined business rules to the first and second financing offers in order to selectively present at least one of the first or second financing offers to the consumer.

11. The licensing and subscription management system of claim 1, wherein the suite of invokable tenant-selectable features includes one or more of a catalog concierge, a membership status, an instant promotion, a tenant practice insight, a tenant patient insight, a tenant patient import, a tenant patient checkout, a next day funding, a card present payment status or checkout flow, a card not present payment status or check out flow, a risk monitoring option or status, a dispute management tool, a tenant practice onboarding tool, a tenant patient onboarding tool, a multi-location payment tool, a multi-device payment tool, a license fee and subscription management tool, a payment operations analysis, a device management tool, and a PCI compliance monitoring tool.

12. A method to generate user interfaces for a multi-tenant licensing and subscription management system, the method comprising:
presenting, for a tenant practice in a multi-tenant network, an interaction platform for receiving, via a platform user interface, health-related subscriptions from a tenant patient, the presented platform including a suite of invokable tenant-selectable features for processing data relating to the subscriptions and/or operations of the tenant practice;
including, in the platform user interface, a first toggle feature selectable by the tenant practice to toggle between a tenant practice view flow and a tenant patient view flow;
via an interface in the tenant practice view flow, receiving from a tenant practice, a selection of one or more of the tenant-selectable features;
calculating a tenant-configurable practice license fee based on the selection of one or more of the tenant-selectable features;
accessing first order data relating to a first subscription offering to the tenant patient, the first order data including a first set of attributes relating to the first subscription offering;
accessing second order data related to a second subscription offering to the tenant patient, the second order data including a second set of attributes related to the second subscription offering;
combining the license fee and the first and second order data into a licensing and subscription data structure that includes quantity data and period data for each of the first and second subscription offerings;
calculating a combined one-time payment amount for both the first and second subscription offerings based on the quantity data;
calculating a combined periodic monthly subscription payment amount for both the first and the second subscription offerings based on the quantity and period data;
causing presentation, in a user interface in the tenant patient view flow, of both the combined one-time payment amount and the combined monthly subscription payment amount; and
causing presentation, in a user interface in the tenant practice view flow, of the tenant-configurable practice license fee.

13. The method of claim 12 wherein the presentation comprises presentation of a first user interface element to present the combined one-time payment amount and a second user element to present the combined monthly subscription payment amount, and presentation of a second toggle feature to toggle between the presentations of the first and second user interface elements.

14. The method of claim 12, comprising receiving third order data relating to a third offering, the third offering having a one-time payment option only, wherein the presentation includes a presentation of a one-time payment amount related to the third offering in conjunction with each of the combined one-time payment amount and the combined monthly subscription payment amount.

15. The method of claim 12, wherein each of the first and second set of attributes comprises an item identifier associated with at least one of an item or a service included in the offering.

16. The method of claim 12, wherein each of the first and second set of attributes comprises a recurring attribute identifying the respective offering as being recurring offering, and wherein the combining of the first and second order data is performed based on each of the first and second subscription offerings being identified as recurring offerings.

17. The method of claim 12, including communicating the combined monthly subscription payment amount from the licensing and licensing and subscription management system to a financial exchange system, the financial exchange system operating to present financing options relating to the combined monthly subscription payment amount to financiers.

18. The method of claim 17, wherein the communication of the combined monthly subscription payment amount includes communicating further information pertaining to each of the first and second subscription offerings, the further information including identification information for a provider of the subscription offering, and identification information for a consumer of the subscription offering.

19. The method of claim 17, including receiving, at the financial exchange system, a financing offer related to at least one of the first or the second subscription offerings, the financing offer including financing terms, and further including communicating the financing offer from the financial exchange system to the licensing and licensing and subscription management system for presentation to a consumer.

20. The method of claim 19, wherein the financing offer includes both a first financing offer pertaining to the first subscription offering and a second financing offer pertaining to the second subscription offering.

21. The method of claim 20, wherein the licensing and licensing and subscription management system automatically applies predefined business rules to the first and second financing offers in order to selectively present at least one of the first or second financing offers to the consumer.

22. The method of claim 12, wherein the suite of invokable tenant-selectable features includes one or more of a catalog concierge, a membership status, an instant promotion, a tenant practice insight, a tenant patient insight, a tenant patient import, a tenant patient checkout, a next day funding, a card present payment status or checkout flow, a card not present payment status or check out flow, a risk monitoring option or status, a dispute management tool, a tenant practice onboarding tool, a tenant patient onboarding tool, a multi-location payment tool, a multi-device payment tool, a license fee and subscription management tool, a payment operations analysis, a device management tool, and a PCI compliance monitoring tool.

23. A non-transitory computer-readable storage medium, the computer-readable storage medium including instructions that when executed by a computer, cause the computer to:
presenting, for a tenant practice in a multi-tenant network, an interaction platform for receiving, via a platform user interface, health-related subscriptions from a tenant patient, the presented platform including a suite of invokable tenant-selectable features for processing data relating to the subscriptions and/or operations of the tenant practice;
including, in the platform user interface, a first toggle feature selectable by the tenant practice to toggle between a tenant practice view flow and a tenant patient view flow;
via an interface in the tenant practice view flow, receiving from a tenant practice, a selection of one or more of the tenant-selectable features;
calculating a tenant-configurable practice license fee based on the selection of one or more of the tenant-selectable features;
accessing first order data relating to a first subscription offering to the tenant patient, the first order data including a first set of attributes relating to the first subscription offering;
accessing second order data related to a second subscription offering to the tenant patient, the second order data including a second set of attributes related to the second subscription offering;
combining the license fee and the first and second order data into a licensing and subscription data structure that includes quantity data and period data for each of the first and second subscription offerings;
calculating a combined one-time payment amount for both the first and second subscription offerings based on the quantity data;
calculating a combined periodic monthly subscription payment amount for both the first and the second subscription offerings based on the quantity and period data;
causing presentation, in a user interface in the tenant patient view flow, of both the combined one-time payment amount and the combined monthly subscription payment amount; and
causing presentation, in a user interface in the tenant practice view flow, of the tenant-configurable practice license fee.

24. The non-transitory computer-readable storage medium of claim 23, wherein the suite of invokable tenant-selectable features includes one or more of a catalog concierge, a membership status, an instant promotion, a tenant practice insight, a tenant patient insight, a tenant patient import, a tenant patient checkout, a next day funding, a card present payment status or checkout flow, a card not present payment status or check out flow, a risk monitoring option or status, a dispute management tool, a tenant practice onboarding tool, a tenant patient onboarding tool, a multi-location payment tool, a multi-device payment tool, a license fee and subscription management tool, a payment operations analysis, a device management tool, and a PCI compliance monitoring tool.
